(19) United States
(12) Patent Application Publication
(10) Pub. No.: US 2022/0060265 A1
(43) Pub. Date: Feb. 24, 2022

(54) SOUNDING REFERENCE SIGNAL TRANSMISSION FOR UE-TO-UE CROSS-LINK INTERFERENCE MEASUREMENT

(71) Applicants: Huilin XU, San Diego, CA (US); Jay Kumar SUNDARARAJAN, San Diego, CA (US); Alexandros MANOLAKOS, San Diego, CA (US); Tingfang JI, San Diego, CA (US); Joseph Binamira SORIAGA, San Diego, CA (US); Xiao Feng WANG, San Diego, CA (US); Heechoon LEE, San Diego, CA (US); Seyedkianoush HOSSEINI, San Diego, CA (US); Yeliz TOKGOZ, San Diego, CA (US); Naga BHUSHAN, San Diego, CA (US); Yi HUANG, San Diego, CA (US); Yiqing CAO, San Diego, CA (US); Yuwei REN, San Diego, CA (US); Qualcomm Incorporated, San Diego, CA (US)

(72) Inventors: Huilin XU, Temecula, CA (US); Jay Kumar SUNDARARAJAN, San Diego, CA (US); Alexandros MANOLAKOS, Escondido, CA (US); Tingfang JI, San Diego, CA (US); Joseph Binamira SORIAGA, San Diego, CA (US); Xiao Feng WANG, San Diego, CA (US); Heechoon LEE, San Diego, CA (US); Seyedkianoush HOSSEINI, San Diego, CA (US); Yeliz TOKGOZ, San Diego, CA (US); Naga BHUSHAN, San Diego, CA (US); Yi HUANG, San Diego, CA (US); Yiqing CAO, Beijing (CN); Yuwei REN, Beijing (CN)

(21) Appl. No.: 17/418,350

(22) PCT Filed: Jan. 10, 2020
(86) PCT No.: PCT/CN2020/071310

§ 371 Date: Jun. 25, 2021

(30) Foreign Application Priority Data
Jan. 11, 2019 (CN) PCT/CN2019/071358

(51) Int. Cl. H04B 17/309; H04J 11/00; H04L 1/00; H04L 5/00; H04L 5/14; H04W 24/10

(52) U.S. Cl. CPC H04B 17/309; H04J 11/0023; H04L 1/0013; H04L 5/0012; H04W 72/0446; H04L 5/0094; H04L 5/1469; H04W 24/10; H04L 5/0051

(57) ABSTRACT

Methods, systems, and devices for wireless communications are described. A user equipment (UE), served by a cell of a base station, may identify a time division duplexing (TDD) configuration for a first cell, wherein the TDD configuration includes a symbol pattern for a slot. The base station may determine an overlap between a downlink symbol or a flexible symbol and an uplink symbol during symbols of the slot based on a TDD configuration. A first UE may receive a configuration for transmitting a cross-link interference (CLI) sounding reference signal (SRS) to a second UE according to the configuration. The second UE may measure the CLI SRS and report the measurement.

### CROSS REFERENCE TO RELATED APPLICATIONS

The present application is a 371 national phase filing of International Patent Application No. PCT/CN2020/071310 by XU et. al., titled “SOUNDING REFERENCE SIGNAL TRANSMISSION FOR UE-TO-UE CROSS-LINK INTERFERENCE MEASUREMENT,” filed Jan. 10, 2020; and to International Patent Application No. PCT/CN2019/071358 by XU et. al., titled “SOUNDING REFERENCE SIGNAL TRANSMISSION FOR UE-TO-UE CROSS-LINK INTERFERENCE MEASUREMENT,” filed Jan. 11, 2019, each of which is assigned to the assignee hereof, and each of which is expressly incorporated by reference in its entirety herein.

### BACKGROUND

The following relates generally to wireless communications, and more specifically to sounding reference signal transmission for UE-to-UE cross-link interference measurement.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include a number of base stations or network access nodes, each simultaneously supporting communication for multiple communication devices, which may be otherwise known as user equipment (UE).

Neighboring cells in a time domain duplexed (TDD) system may use different configurations for TDD communications. In some cases, the different TDD configurations may lead to overlap for transmission in opposite directions. For example, an uplink transmission by a first UE may interfere with downlink reception at a second UE if the uplink transmission and downlink reception are schedule for the same time. Interference between UEs served by different base stations in a TDD system may be known as cross-link interference (CLI). Current techniques for managing CLI in a TDD system may result in inefficient use of communication resources.

### SUMMARY

The described techniques relate to improved methods, systems, devices, and apparatuses that support sounding reference signal (SRS) transmission for user equipment (UE)-to-UE cross-link interference (CLI) measurement. Generally, the described techniques provide for measuring, at a victim UE, CLI SRS transmissions from an aggressor UE and reporting the measurements to assist a wireless network in managing CLI. A wireless communications system may use time division duplexed (TDD) communications, where a wireless channel or carrier is used for both uplink transmissions and downlink transmissions. In some cases, a cell may modify its slot format to follow a change of traffic. For example, if the traffic in the cell shifts toward being more uplink-heavy, the cell may change the slot format of the TDD configuration to using slots which have more uplink symbol periods. The base station may indicate the dynamic TDD configuration to UEs in the cell, and the new TDD configuration may be used for communications in the cell. In some cases, neighboring cells may use different TDD configurations, which can lead to conflicting symbol periods. For example, a symbol period of a first cell may be configured for downlink, where the same symbol period is configured for uplink in a second cell. If a first UE in a first cell is configured for uplink transmission during a symbol period, a second UE in a second cell is configured to receive a downlink transmission during the symbol period, and the first UE and the second UE are in close proximity, the uplink transmission of the first UE may cause interference to reception of the downlink transmission at the second UE. This type of interference may be referred to as CLI.

To manage CLI in the wireless communications system, a first UE scheduled to cause the CLI may transmit a reference signal during the one or more interfering symbol periods. A second UE, which would be the victim of the UE-to-UE CLI, may be configured to receive and measure the reference signal during the one or more symbol periods. The second UE may provide a measurement report to its serving cell to assist the network in determining an appropriate tolerance or mitigation action for the UE-to-UE CLI. A first base station providing the first cell may configure the first UE to transmit a reference signal, such as an SRS, during the uplink symbol periods of a slot which are scheduled to cause CLI. A second base station providing the second cell may configure the second UE to receive and measure the reference signal during the corresponding downlink symbol periods of the slot. Different configurations for the CLI SRS transmission, reception, and measurement may be configured. For example, a timing advance, a transmit power, a resource type, and frequency hopping may be configured for the CLI SRS transmission.

A method of wireless communication at a first UE served by a cell associated with a base station is described. The method may include identifying a TDD configuration for the cell, where the TDD configuration includes a symbol pattern for a slot of a set of slots, receiving a configuration for transmitting a CLI SRS in the slot, and transmitting, to a second UE, the CLI SRS in the slot according to the configuration.

An apparatus for wireless communication at a first UE served by a cell associated with a base station is described. The apparatus may include a processor, memory in electronic communication with the processor, and instructions stored in the memory. The instructions may be executable by the processor to cause the apparatus to identify a TDD configuration for the cell, where the TDD configuration includes a symbol pattern for a slot of a set of slots, receive a configuration for transmitting a CLI SRS in the slot, and transmit, to a second UE, the CLI SRS in the slot according to the configuration.

Another apparatus for wireless communication at a first UE served by a cell associated with a base station is described. The apparatus may include means for identifying a TDD configuration for the cell, where the TDD configuration includes a symbol pattern for a slot of a set of slots, receiving a configuration for transmitting a CLI SRS in the slot, and transmitting, to a second UE, the CLI SRS in the slot according to the configuration.

A non-transitory computer-readable medium storing code for wireless communication at a first UE served by a cell associated with a base station is described. The code may include instructions executable by a processor to identify a TDD configuration for the cell, where the TDD configuration includes a symbol pattern for a slot of a set of slots, receive a configuration for transmitting a CLI SRS in the slot, and transmit, to a second UE, the CLI SRS in the slot according to the configuration.

Some examples of the method, apparatuses, and non-transitory computer-readable medium described herein may further include operations, features, means, or instructions for receiving a second configuration for transmitting a second SRS, the second configuration configuring the second SRS according to one or more of a first set of symbols of the set of slots subject to a restriction, where the first configuration configures the CLI SRS for transmission according to one or more of a second set of symbols of the slot not subject to the restriction.

In some examples of the method, apparatuses, and non-transitory computer-readable medium described herein, the transmitting the CLI SRS applies a timing advance for uplink shared channel transmissions.

In some examples of the method, apparatuses, and non-transitory computer-readable medium described herein, the transmitting the CLI SRS applies a timing advance for the CLI SRS that may be different from a timing advance for uplink shared channel transmissions.

Some examples of the method, apparatuses, and non-transitory computer-readable medium described herein may further include operations, features, means, or instructions for determining that an uplink transmission during an uplink symbol period subsequent to the CLI SRS transmission may be scheduled to collide with the CLI SRS transmission based on the timing advance for the CLI SRS and the timing advance for uplink shared channel transmissions, and dropping the uplink transmission from the uplink symbol period.

In some examples of the method, apparatuses, and non-transitory computer-readable medium described herein, the timing advance for the CLI SRS may be a zero-valued timing advance.

Some examples of the method, apparatuses, and non-transitory computer-readable medium described herein may further include operations, features, means, or instructions for receiving the timing advance for the CLI SRS from the base station.

In some examples of the method, apparatuses, and non-transitory computer-readable medium described herein, a transmit power for the CLI SRS may be based on a transmit power control (TPC) loop for physical uplink shared channel transmissions.

In some examples of the method, apparatuses, and non-transitory computer-readable medium described herein, a transmit power for the CLI SRS may be based on an open loop power control parameter for the CLI SRS.

In some examples of the method, apparatuses, and non-transitory computer-readable medium described herein, the open loop power control parameter includes a fixed power level for CLI SRS transmissions.

In some examples of the method, apparatuses, and non-transitory computer-readable medium described herein, the CLI SRS may be configured to be transmitted aperiodically, semi-persistently, or periodically.

In some examples of the method, apparatuses, and non-transitory computer-readable medium described herein, the CLI SRS may be configured to be transmitted according to interlaced frequency resources, transmitted using a code of a set of orthogonal codes, or transmitted according to a frequency hopping pattern.

In some examples of the method, apparatuses, and non-transitory computer-readable medium described herein, the CLI SRS may be transmitted on a set of beams corresponding to a set of transmit ports.

Some examples of the method, apparatuses, and non-transitory computer-readable medium described herein may further include operations, features, means, or instructions for applying a precoding matrix to the CLI SRS transmission corresponding to a serving precoding matrix.

In some examples of the method, apparatuses, and non-transitory computer-readable medium described herein, the first UE may be served by a first cell of a first base station and the second UE may be served by a second cell of a second, different base station.

In some examples of the method, apparatuses, and non-transitory computer-readable medium described herein, the first UE and second UEs may be served by a same cell.

A method of wireless communication at a base station is described. The method may include identifying a first TDD configuration for a cell of the base station, where the first TDD configuration includes a first symbol pattern for the cell for a slot of a set of slots, determining an overlap between a downlink symbol or a flexible symbol and an uplink symbol during one or more symbols of the slot based on a second TDD configuration, where the second TDD configuration includes a second symbol pattern for the slot of the set of slots, and transmitting a configuration to a first UE served by the base station for transmitting a CLI SRS in the slot based on the overlap, where the CLI SRS is configured for transmission in a downlink symbol or a flexible symbol of the second symbol pattern for the slot.

An apparatus for wireless communication at a base station is described. The apparatus may include a processor, memory in electronic communication with the processor, and instructions stored in the memory. The instructions may be executable by the processor to cause the apparatus to identify a first TDD configuration for a cell of the base station, where the first TDD configuration includes a first symbol pattern for the cell for a slot of a set of slots, determine an overlap between a downlink symbol or a flexible symbol and an uplink symbol during one or more symbols of the slot based on a second TDD configuration, where the second TDD configuration includes a second symbol pattern for the slot of the set of slots, and transmit a configuration to a first UE served by the base station for transmitting a CLI SRS in the slot based on the overlap, where the CLI SRS is configured for transmission in a downlink symbol or a flexible symbol of the second symbol pattern for the slot.

Another apparatus for wireless communication at a base station is described. The apparatus may include means for identifying a first TDD configuration for a cell of the base station, where the first TDD configuration includes a first symbol pattern for the cell for a slot of a set of slots, determining an overlap between a downlink symbol or a flexible symbol and an uplink symbol during one or more symbols of the slot based on a second TDD configuration, where the second TDD configuration includes a second symbol pattern for the slot of the set of slots, and transmitting a configuration to a first UE served by the base station for transmitting a CLI SRS in the slot based on the overlap, where the CLI SRS is configured for transmission in a downlink symbol or a flexible symbol of the second symbol pattern for the slot.

A non-transitory computer-readable medium storing code for wireless communication at a base station is described. The code may include instructions executable by a processor to identify a first TDD configuration for a cell of the base station, where the first TDD configuration includes a first symbol pattern for the cell for a slot of a set of slots, determine an overlap between a downlink symbol or a flexible symbol and an uplink symbol during one or more symbols of the slot based on a second TDD configuration, where the second TDD configuration includes a second symbol pattern for the slot of the set of slots, and transmit a configuration to a first UE served by the base station for transmitting a CLI SRS in the slot based on the overlap, where the CLI SRS is configured for transmission in a downlink symbol or a flexible symbol of the second symbol pattern for the slot.

Some examples of the method, apparatuses, and non-transitory computer-readable medium described herein may further include operations, features, means, or instructions for transmitting a second configuration to the UE for transmitting a second SRS, the second configuration configuring the second SRS according to one or more of a first set of symbols of the slot subject to a restriction, where the first configuration configures the CLI SRS for transmission according to one or more of a second set of symbols of the slot not subject to the restriction.

In some examples of the method, apparatuses, and non-transitory computer-readable medium described herein, the configuration includes a timing advance for the CLI SRS that may be different from a timing advance for uplink shared channel transmissions for the first UE.

Some examples of the method, apparatuses, and non-transitory computer-readable medium described herein may further include operations, features, means, or instructions for determining the timing advance for the CLI SRS for the first UE based on the timing advance for uplink shared channel transmissions for the first UE.

In some examples of the method, apparatuses, and non-transitory computer-readable medium described herein, the configuration includes an open loop power control parameter for the CLI SRS.

In some examples of the method, apparatuses, and non-transitory computer-readable medium described herein, the configuration configures the CLI SRS to be transmitted aperiodically, semi-persistently, or periodically.

In some examples of the method, apparatuses, and non-transitory computer-readable medium described herein, the configuration includes a cell-specific configuration, a group-specific configuration, or a UE-specific configuration for the CLI SRS.

In some examples of the method, apparatuses, and non-transitory computer-readable medium described herein, the configuration configures the CLI SRS to be transmitted according to interlaced frequency resources, transmitted using a code of a set of orthogonal codes, or transmitted according to a frequency hopping pattern.

In some examples of the method, apparatuses, and non-transitory computer-readable medium described herein, the base station serves the first UE via a first cell and the second UE may be served by a second cell of a second, different base station.

In some examples of the method, apparatuses, and non-transitory computer-readable medium described herein, the base station serves the first UE and the second UE via a same cell.

In some examples of the method, apparatuses, and non-transitory computer-readable medium described herein, the base station serves the first UE via a first cell and the second UE may be served by a second cell of a second, different base station.

In some examples of the method, apparatuses, and non-transitory computer-readable medium described herein, the base station serves the first UE and the second UE via a same cell.

A method of wireless communication at a first UE served by a cell associated with a base station is described. The method may include identifying a TDD configuration for the cell, where the TDD configuration includes a symbol pattern for a slot of a set of slots, receiving a configuration for receiving a CLI SRS in the slot, where the CLI SRS is transmitted by a second UE, and performing a measurement on the CLI SRS in the slot based on the TDD configuration.

An apparatus for wireless communication at a first UE served by a cell associated with a base station is described. The apparatus may include a processor, memory in electronic communication with the processor, and instructions stored in the memory. The instructions may be executable by the processor to cause the apparatus to identify a TDD configuration for the cell, where the TDD configuration includes a symbol pattern for a slot of a set of slots, receive a configuration for receiving a CLI SRS in the slot, where the CLI SRS is transmitted by a second UE, and perform a measurement on the CLI SRS in the slot based on the TDD configuration.

Another apparatus for wireless communication at a first UE served by a cell associated with a base station is described. The apparatus may include means for identifying a TDD configuration for the cell, where the TDD configuration includes a symbol pattern for a slot of a set of slots, receiving a configuration for receiving a CLI SRS in the slot, where the CLI SRS is transmitted by a second UE, and performing a measurement on the CLI SRS in the slot based on the TDD configuration.

A non-transitory computer-readable medium storing code for wireless communication at a first UE served by a cell associated with a base station is described. The code may include instructions executable by a processor to identify a TDD configuration for the cell, where the TDD configuration includes a symbol pattern for a slot of a set of slots, receive a configuration for receiving a CLI SRS in the slot, where the CLI SRS is transmitted by a second UE, and perform a measurement on the CLI SRS in the slot based on the TDD configuration.

Some examples of the method, apparatuses, and non-transitory computer-readable medium described herein may further include operations, features, means, or instructions for identifying a second TDD configuration for the cell including a second symbol pattern for the slot based on the configuration for receiving the CLI SRS in the slot, and performing the measurement on the CLI SRS in the slot based on the second symbol pattern for the slot.

In some examples of the method, apparatuses, and non-transitory computer-readable medium described herein, a first symbol of the slot may be configured as an uplink symbol in the symbol pattern for the slot, the first symbol of the slot may be configured as a flexible symbol or a downlink symbol in the second symbol pattern for the slot, and the CLI SRS may be received during the first symbol.

Some examples of the method, apparatuses, and non-transitory computer-readable medium described herein may further include operations, features, means, or instructions for receiving an indicator that a non-zero power (NZP) channel state information reference signal (CSI-RS) resource or a CSI interference measurement (CSI-IM) may be configured as a measurement resource for the CLI SRS.

Some examples of the method, apparatuses, and non-transitory computer-readable medium described herein may further include operations, features, means, or instructions for receiving an indicator that at least a portion of a zero power CSI-RS resource may be configured for rate matching a PDSCH transmission around the measurement resource for the CLI SRS.

In some examples of the method, apparatuses, and non-transitory computer-readable medium described herein, the measurement may be an RSSI measurement or an RSRP measurement.

Some examples of the method, apparatuses, and non-transitory computer-readable medium described herein may further include operations, features, means, or instructions for reporting the measurement for the CLI SRS to the base station.

In some examples of the method, apparatuses, and non-transitory computer-readable medium described herein, the measurement for the CLI SRS may be configured to be performed aperiodically, semi-persistently, or periodically.

In some examples of the method, apparatuses, and non-transitory computer-readable medium described herein, the CLI SRS may be configured to be transmitted according to interlaced frequency resources, transmitted using a code of a set of orthogonal codes, or transmitted according to a frequency hopping pattern.

In some examples of the method, apparatuses, and non-transitory computer-readable medium described herein, the CLI SRS may be configured to be transmitted on a set of beams corresponding to a set of transmit ports.

In some examples of the method, apparatuses, and non-transitory computer-readable medium described herein, the first UE may be served by a first cell of a first base station and the second UE may be served by a second cell of a second, different base station.

In some examples of the method, apparatuses, and non-transitory computer-readable medium described herein, the first UE and second UEs may be served by a same cell.

A method of wireless communication at a base station is described. The method may include identifying a first TDD configuration for a cell of the base station, where the first TDD configuration includes a first symbol pattern for the cell for a slot of a set of slots, determining an overlap between a downlink symbol or a flexible symbol and an uplink symbol during one or more symbols of the slot based on a second TDD configuration, where the second TDD configuration includes a second symbol pattern for the slot of the set of slots, transmitting a configuration to a first UE served by the base station for performing a measurement of a CLI SRS in the slot based on the overlap, where the CLI SRS is configured to be transmitted by a second UE, and receiving, from the first UE, a report including the measurement based on the CLI SRS.

An apparatus for wireless communication at a base station is described. The apparatus may include a processor, memory in electronic communication with the processor, and instructions stored in the memory. The instructions may be executable by the processor to cause the apparatus to identify a first TDD configuration for a cell of the base station, where the first TDD configuration includes a first symbol pattern for the cell for a slot of a set of slots, determine an overlap between a downlink symbol or a flexible symbol and an uplink symbol during one or more symbols of the slot based on a second TDD configuration, where the second TDD configuration includes a second symbol pattern for the slot of the set of slots, transmit a configuration to a first UE served by the base station for performing a measurement of a CLI SRS in the slot based on the overlap, where the CLI SRS is configured to be transmitted by a second UE, and receive, from the first UE, a report including the measurement based on the CLI SRS.

Another apparatus for wireless communication at a base station is described. The apparatus may include means for identifying a first TDD configuration for a cell of the base station, where the first TDD configuration includes a first symbol pattern for the cell for a slot of a set of slots, determining an overlap between a downlink symbol or a flexible symbol and an uplink symbol during one or more symbols of the slot based on a second TDD configuration, where the second TDD configuration includes a second symbol pattern for the slot of the set of slots, transmitting a configuration to a first UE served by the base station for performing a measurement of a CLI SRS in the slot based on the overlap, where the CLI SRS is configured to be transmitted by a second UE, and receiving, from the first UE, a report including the measurement based on the CLI SRS.

A non-transitory computer-readable medium storing code for wireless communication at a base station is described. The code may include instructions executable by a processor to identify a first TDD configuration for a cell of the base station, where the first TDD configuration includes a first symbol pattern for the cell for a slot of a set of slots, determine an overlap between a downlink symbol or a flexible symbol and an uplink symbol during one or more symbols of the slot based on a second TDD configuration, where the second TDD configuration includes a second symbol pattern for the slot of the set of slots, transmit a configuration to a first UE served by the base station for performing a measurement of a CLI SRS in the slot based on the overlap, where the CLI SRS is configured to be transmitted by a second UE, and receive, from the first UE, a report including the measurement based on the CLI SRS.

Some examples of the method, apparatuses, and non-transitory computer-readable medium described herein may further include operations, features, means, or instructions for determining a third symbol pattern for the cell for the slot, and transmitting an indicator for the third symbol pattern for the slot to the first UE.

In some examples of the method, apparatuses, and non-transitory computer-readable medium described herein, a first symbol of the slot may be configured as an uplink symbol in the first symbol pattern for the slot, the first symbol of the slot may be configured as a flexible symbol or a downlink symbol in the third symbol pattern for the slot, and the CLI SRS may be transmitted by the second UE during the first symbol.

Some examples of the method, apparatuses, and non-transitory computer-readable medium described herein may further include operations, features, means, or instructions for transmitting an indicator that a non-zero power (NZP) channel state information reference signal (CSI-RS) resource or a CSI interference measurement (CSI-IM) may be configured as a measurement resource for the CLI SRS.

Some examples of the method, apparatuses, and non-transitory computer-readable medium described herein may further include operations, features, means, or instructions for transmitting an indicator that at least a portion of a zero power CSI-RS resource may be configured for rate matching a PDSCH transmission around the measurement resource for the CLI SRS.

In some examples of the method, apparatuses, and non-transitory computer-readable medium described herein, the measurement may be an RSSI measurement or an RSRP measurement.

Some examples of the method, apparatuses, and non-transitory computer-readable medium described herein may further include operations, features, means, or instructions for configuring the first UE to perform the measurement of the CLI SRS aperiodically, semi-persistently, or periodically.

In some examples of the method, apparatuses, and non-transitory computer-readable medium described herein, the CLI SRS may be configured to be transmitted according to interlaced frequency resources, transmitted using a code of a set of orthogonal codes, or transmitted according to a frequency hopping pattern.

### BRIEF DESCRIPTION OF THE DRAWINGS

FIG. 1 illustrates an example of a system for wireless communications that supports sounding reference signal (SRS) transmission for user equipment (UE)-to-UE cross-link interference (CLI) measurement in accordance with aspects of the present disclosure.

FIG. 2 illustrates an example of a wireless communications system that supports SRS transmission for UE-to-UE CLI measurement in accordance with aspects of the present disclosure.

FIG. 3 illustrates an example of a CLI measurement configuration that supports SRS transmission for UE-to-UE CLI measurement in accordance with aspects of the present disclosure.

FIG. 4 illustrates an example of a dynamic time division duplex (TDD) configuration and a CLI measurement configuration that supports SRS transmission for UE-to-UE CLI measurement in accordance with aspects of the present disclosure

FIG. 5 illustrates an example of a CLI measurement configuration that supports SRS transmission for UE-to-UE CLI measurement in accordance with aspects of the present disclosure.

FIG. 6 illustrates an example of a timing advance configuration that supports SRS transmission for UE-to-UE CLI measurement in accordance with aspects of the present disclosure.

FIG. 7 illustrates an example of a process flow that supports SRS transmission for UE-to-UE CLI measurement in accordance with aspects of the present disclosure.

FIGS. 8 and 9 show block diagrams of devices that support sounding reference signal transmission for UE-to-UE CLI measurement in accordance with aspects of the present disclosure.

FIG. 10 shows a block diagram of a communications manager that supports SRS transmission for UE-to-UE CLI measurement in accordance with aspects of the present disclosure.

FIG. 11 shows a diagram of a system including a device that supports SRS transmission for UE-to-UE CLI measurement in accordance with aspects of the present disclosure.

FIGS. 12 and 13 show block diagrams of devices that support SRS transmission for UE-to-UE CLI measurement in accordance with aspects of the present disclosure.

FIG. 14 shows a block diagram of a communications manager that supports SRS transmission for UE-to-UE CLI measurement in accordance with aspects of the present disclosure.

FIG. 15 shows a diagram of a system including a device that supports SRS transmission for UE-to-UE CLI measurement in accordance with aspects of the present disclosure.

FIGS. 16 through 20 show flowcharts illustrating methods that support SRS transmission for UE-to-UE CLI measurement in accordance with aspects of the present disclosure.

### DETAILED DESCRIPTION

A wireless communications system may employ time division duplexed (TDD) communications, where a wireless channel is used for both uplink transmissions and downlink transmissions. In a TDD system with macro cells which provide a wide coverage area, the macro cells may often use the same TDD uplink/downlink configuration. For example, multiple macro cells may use the same slot format which provides, on average, the largest throughput for the large number of users connected to the macro cells. For small cells (e.g., with a cell radius of a few hundred meters), TDD uplink/downlink configurations may dynamically change to follow a change of traffic. For example, if the traffic in a small cell shifts toward being more uplink-heavy, the TDD configuration of the small cell may change to using slots which have more uplink symbol periods. The TDD configuration of the small cell may be dynamically indicated to user equipments (UEs) in the small cell by, for example, a slot format indicator (SFI) in downlink control information. Additionally, or alternatively, the TDD configuration of the small cell may be semi-statically configured by higher layer signaling, such as radio resource control (RRC) signaling.

In some cases, neighboring cells may use different TDD configurations, which can lead to conflicting symbol periods. For example, a symbol period of a first cell may be configured for downlink, where the same symbol period is configured for uplink in a second cell. If a first UE in a first cell is configured for uplink transmission during a symbol period, a second UE in a second cell is configured to receive a downlink transmission during the symbol period, and the first UE and the second UE are in close proximity, the uplink transmission of the first UE may cause interference to reception of the downlink transmission at the second UE. This type of interference may be referred to cross-link interference (CLI). Generally, differing TDD configurations may result in UE-to-UE CLI when an uplink symbol of one cell collides with a downlink symbol of a nearby cell. CLI may occur near or between cell edge UEs of nearby cells.

To manage CLI in the wireless communications system, a first UE scheduled to cause UE-to-UE CLI with an uplink transmission in one or more symbol periods may transmit a reference signal during the one or more symbol periods. A second UE, which would be the victim of the UE-to-UE CLI, may be configured to receive and measure the reference signal during the one or more symbol periods. The second UE may provide a measurement report to its serving cell to assist the network in determining an appropriate tolerance or mitigation action for the UE-to-UE CLI. In an example, a first TDD configuration for a first cell with the first UE may have one or more uplink symbol periods which are scheduled to collide with one or more downlink symbol periods of a second TDD configuration for a second cell with the second UE.

A first base station providing the first cell may configure the first UE to transmit a reference signal, such as an SRS, during the uplink symbol periods of a slot which are schedule to cause CLI. A second base station providing the second cell may configure the second UE to receive the reference signal during the corresponding downlink symbol periods of the slot. In some cases, the UE may transmit the CLI reference signal in the interfering symbols of the uplink/downlink. In some other examples, the network (e.g., the base stations or another entity) may configure a separate, dynamic TDD configuration for the victim UE to perform CLI SRS measurement. Different configurations for the CLI SRS transmission, reception, and measurement may be configured. For example, a timing advance, a transmit power, a resource type, and a frequency hopping pattern may be configured for the CLI SRS. In some cases, the first base station and the second base station may be the same base station, for example where the base station implements the techniques described herein to manage CLI between two UEs with different TDD configurations.

Aspects of the disclosure are initially described in the context of a wireless communications system. Aspects of the disclosure are further illustrated by and described with reference to apparatus diagrams, system diagrams, and flowcharts that relate to SRS transmission for UE-to-UE cross-link interference measurement.

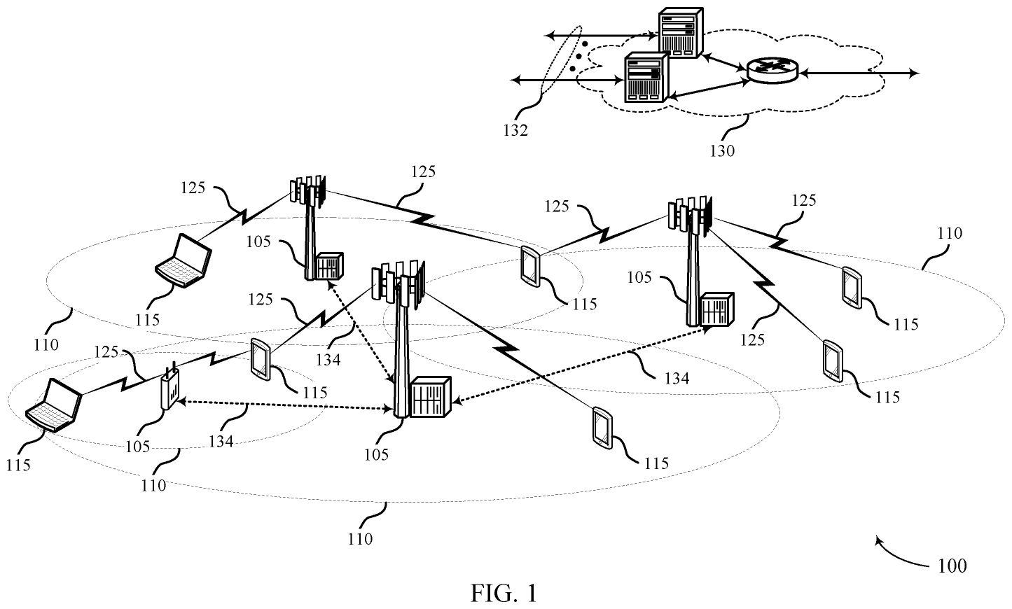

FIG. 1 illustrates an example of a wireless communications system 100 that supports sounding reference signal transmission for UE-to-UE cross-link interference measurement in accordance with aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, an LTE-A Pro network, or a New Radio (NR) network. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation NodeB or giga-NodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions from a base station 105 to a UE 115. Downlink transmissions may also be called forward link transmissions while uplink transmissions may also be called reverse link transmissions.

The geographic coverage area 110 for a base station 105 may be divided into sectors making up a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1, N2, N3, or other interface). Base stations 105 may communicate with one another over backhaul links 134 (e.g., via an X2, Xn, or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that may be capable of tolerating interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115. However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a carrier aggregation configuration in conjunction with component carriers operating in a licensed band (e.g., LAA). Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some examples, base station 105 or UE 115 may be equipped with multiple antennas, which may be used to employ techniques such as transmit diversity, receive diversity, multiple-input multiple-output (MIMO) communications, or beamforming. For example, wireless communications system 100 may use a transmission scheme between a transmitting device (e.g., a base station 105) and a receiving device (e.g., a UE 115), where the transmitting device is equipped with multiple antennas and the receiving device is equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream, and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a spatial path between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may use multiple antennas or antenna arrays to conduct beamforming operations for directional communications with a UE 115. For instance, some signals (e.g., synchronization signals, reference signals, beam selection signals, or other control signals) may be transmitted by a base station 105 multiple times in different directions, which may include a signal being transmitted according to different beamforming weight sets associated with different directions of transmission. Transmissions in different beam directions may be used to identify (e.g., by the base station 105 or a receiving device, such as a UE 115) a beam direction for subsequent transmission and/or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based at least in in part on a signal that was transmitted in different beam directions. For example, a UE 115 may receive one or more of the signals transmitted by the base station 105 in different directions, and the UE 115 may report to the base station 105 an indication of the signal it received with a highest signal quality, or an otherwise acceptable signal quality. Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115), or transmitting a signal in a single direction (e.g., for transmitting data to a receiving device).

A receiving device (e.g., a UE 115, which may be an example of a mmW receiving device) may try multiple receive beams when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions. In some examples a receiving device may use a single receive beam to receive along a single beam direction (e.g., when receiving a data signal). The single receive beam may be aligned in a beam direction determined based at least in part on listening according to different receive beam directions (e.g., a beam direction determined to have a highest signal strength, highest signal-to-noise ratio, or otherwise acceptable signal quality based at least in part on listening according to multiple beam directions).

In some cases, the antennas of a base station 105 or UE 115 may be located within one or more antenna arrays, which may support MIMO operations, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Tₛ=1/30,720,000 seconds. Time intervals of a communications resource may be organized according to radio frames each having a duration of 10 milliseconds (ms), where the frame period may be expressed as T_{f}=307,200 Tₛ. The radio frames may be identified by a system frame number (SFN) ranging from 0 to 1023. Each frame may include 10 subframes numbered from 0 to 9, and each subframe may have a duration of 1 ms. A subframe may be further divided into 2 slots each having a duration of 0.5 ms, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols. In some instances, a symbol of a mini-slot or a mini-slot may be the smallest unit of scheduling. Each symbol may vary in duration depending on the subcarrier spacing or frequency band of operation, for example. Further, some wireless communications systems may implement slot aggregation in which multiple slots or mini-slots are aggregated together and used for communication between a UE 115 and a base station 105.

The term “carrier” refers to a set of radio frequency spectrum resources having a defined physical layer structure for supporting communications over a communication link 125. For example, a carrier of a communication link 125 may include a portion of a radio frequency spectrum band that is operated according to physical layer channels for a given radio access technology. Each physical layer channel may carry user data, control information, or other signaling. A carrier may be associated with a pre-defined frequency channel (e.g., an evolved universal mobile telecommunication system terrestrial radio access (E-UTRA) absolute radio frequency channel number (EARFCN)), and may be positioned according to a channel raster for discovery by UEs 115. Carriers may be downlink or uplink (e.g., in an FDD mode), or be configured to carry downlink and uplink communications (e.g., in a TDD mode). In some examples, signal waveforms transmitted over a carrier may be made up of multiple sub-carriers (e.g., using multi-carrier modulation (MCM) techniques such as orthogonal frequency division multiplexing (OFDM) or discrete Fourier transform spread OFDM (DFT-S-OFDM)).

The organizational structure of the carriers may be different for different radio access technologies (e.g., LTE, LTE-A, LTE-A Pro, NR). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, 20, 40, or 80 MHz). In some examples, each served UE 115 may be configured for operating over portions or all of the carrier bandwidth. In other examples, some UEs 115 may be configured for operation using a narrowband protocol type that is associated with a predefined portion or range (e.g., set of subcarriers or RBs) within a carrier (e.g., “in-band” deployment of a narrowband protocol type).

In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme). Thus, the more resource elements that a UE 115 receives and the higher the order of the modulation scheme, the higher the data rate may be for the UE 115. In MIMO systems, a wireless communications resource may refer to a combination of a radio frequency spectrum resource, a time resource, and a spatial resource (e.g., spatial layers), and the use of multiple spatial layers may further increase the data rate for communications with a UE 115.

Devices of the wireless communications system 100 (e.g., base stations 105 or UEs 115) may have a hardware configuration that supports communications over a particular carrier bandwidth or may be configurable to support communications over one of a set of carrier bandwidths. In some examples, the wireless communications system 100 may include base stations 105 and/or UEs 115 that support simultaneous communications via carriers associated with more than one different carrier bandwidth.

Wireless communications system 100 may support communication with a UE 115 on multiple cells or carriers, a feature which may be referred to as carrier aggregation or multi-carrier operation. A UE 115 may be configured with multiple downlink component carriers and one or more uplink component carriers according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other component carriers, which may include use of a reduced symbol duration as compared with symbol durations of the other component carriers. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications system 100 may be an NR system that may utilize any combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across the frequency domain) and horizontal (e.g., across the time domain) sharing of resources.

In some cases, the wireless communications system 100 may use TDD communications, where each base station 105 providing a cell may use a different TDD configuration. In some cases, neighboring cells using different slot formats can lead to conflicting transmission directions in one or more symbol periods. For example, a symbol period of a first cell may be configured for downlink, where the same symbol period is configured for uplink in a second, neighboring cell. If a first UE 115 and a second UE 115 are in close proximity, the uplink transmission of the first UE 115 may cause interference to reception of the downlink transmission at the second UE 115, and this interference may be referred to CLI.

To manage CLI in the wireless communications system, the first UE 115 (e.g., the aggressor UE 115) may transmit a reference signal during the one or more interfering symbol periods. The second UE 115 (e.g., the victim UE 115) may be configured to receive and measure the reference signal during those symbol periods. The second UE 115 may provide a measurement report to its serving cell to assist the network in determining an appropriate tolerance or mitigation action for the UE-to-UE CLI. A first base station 105 providing the first cell may configure the first UE 115 to transmit a reference signal, such as an SRS, during the uplink symbol periods of a slot which may cause CLI. A second base station 105 providing the second cell may configure the second UE 115 to receive and measure the reference signal during the corresponding downlink symbol periods of the slot. Different configurations for the CLI SRS transmission, reception, and measurement may be configured. For example, a timing advance, a transmit power, a resource type, and a frequency hopping pattern may be configured for the CLI SRS.

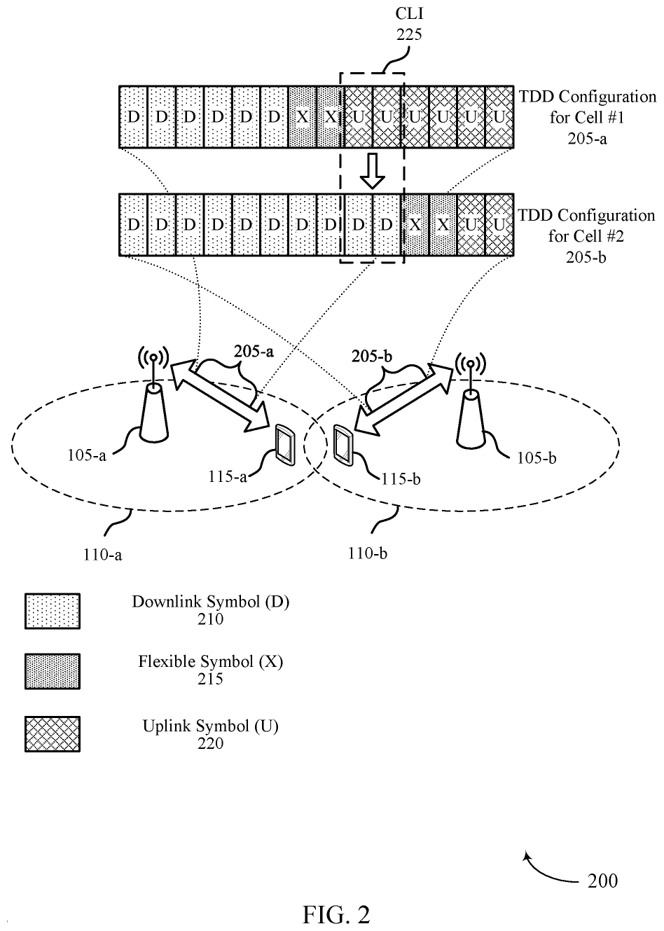

FIG. 2 illustrates an example of a wireless communications system 200 that supports sounding reference signal transmission for UE-to-UE cross-link interference measurement in accordance with aspects of the present disclosure. In some examples, the wireless communications system 200 may implement aspects of wireless communication system 100. The wireless communications system 200 may include UE 115-a and UE 115-b, which may each be an example of a UE 115 as described herein. The wireless communications system 200 may also include base station 105-a and base station 105-b, which may each be an example of a base station 105 as described herein. Base station 105-a and base station 105-b may each be an example of a small cell. The base stations 105 may each be associated with a cell which provides wireless communications with the base station 105 within a coverage area 110. For example, base station 105-a may provide a cell within coverage area 110-a, and base station 105-b may provide a cell within coverage area 110-b.

The wireless communications system 200 may employ TDD communications, where a wireless communications frequency channel is used for both uplink transmissions and downlink transmissions. Each cell may configure a TDD configuration 205 for the cell. For example, the first cell of base station 105-a may use a first TDD configuration 205-a, and the second cell of base station 105-b may use a second TDD configuration 205-b. UEs 115 in these cells may communicate with the base station 105 based on the corresponding TDD configuration 205 for the cell. For example, a slot of a TDD configuration 205 may include symbol periods for downlink symbols 210, flexible symbols 215, or uplink symbols 220, or any combination thereof. The base station 105 may transmit a downlink transmission in a downlink symbol 210, and the UE 115 may transmit an uplink transmission in an uplink symbol 220. Flexible symbols 215 may, in some cases, be used as guard periods between the uplink transmissions and downlink transmissions. A guard period may prevent inter-symbol interference or may provide time for a UE 115 to adjust radio frequency hardware. In some cases, a flexible symbol 215 may be dynamically reconfigured to either a downlink symbol 210 or an uplink symbol 220.

The base stations 105 may dynamically change the TDD configurations 205. In an example, the traffic in the first cell may shift toward being more uplink-heavy, so the first TDD configuration 205-a of the first cell may change to using a slot configuration which has more uplink symbol periods. In some cases, a TDD configuration 205 may be dynamically indicated to UEs in the cell by an SFI in DCI. The DCI conveying the SFI may be transmitted in one of the first few downlink symbols 210 of a slot, and may convey TDD configuration 205 for one or more additional slots. That is, for the illustrated slot, the SFI including the TDD configuration 205 may be received in the slot, or in a previous slot. Additionally or alternatively, the TDD configuration 250 may be semi-statically configured (e.g., included in an RRC configuration) by higher layer signaling, such as RRC signaling.

In some cases, different TDD configurations 205 used by neighboring cells may lead to conflicting transmission directions for some symbol periods of a slot. For example, the 9th and 10th symbol periods of the slot shown may have conflicting directions for the first TDD configuration 205-a and the second TDD configuration 205-b. TDD configuration 205-a may have uplink symbols 220 configured when TDD configuration 205-b has downlink symbols 210 configured. Therefore, UE 115-a in the first cell may be configured to transmit an uplink transmission while UE 115-b in the second cell is configured to receive a downlink transmission. The first cell and the second cell may be neighboring cells, and UE 115-b and UE 115-a may be near each other at the edge of their respective cells. In some cases, the uplink transmission of UE 115-a may cause interference to reception of the downlink transmission at UE 115-b. This type of interference may be referred to as UE-to-UE CLI, shown by CLI 225 at the conflicting symbol periods. Generally, differing TDD configurations 205 may result in UE-to-UE CLI 225 when an uplink symbol of one cell collides with a downlink symbol of another nearby cell. CLI 225 may occur near or between cell edge UEs of nearby cells. The UE 115 transmitting the uplink signal (e.g., UE 115-a here) may be referred to as the aggressor UE 115, and the UE 115 which is receiving the affected downlink transmission (e.g., UE 115-b here) may be referred to as the victim UE 115. In some cases, the CLI 225 may occur between one or more aggressor UEs 115 and one or more victim UEs 115

To manage the CLI 225 in the wireless communications system 200, the aggressor UE 115 may transmit a reference signal during one or more symbol periods in which CLI 225 may occur. The victim UE 115 may be configured to receive and measure the reference signal during those symbol periods. The reference signal may be, for example, an SRS. In some cases, an SRS may be transmitted across a wide bandwidth (e.g., up to or including the entire cell bandwidth). SRS may not be associated with an uplink grant. For example, SRS may be transmitted in different resources than resources granted for uplink shared channel transmissions. In some conventional wireless systems, an SRS may be transmitted by a UE 115 to a base station 105. The base station 105 in these conventional systems may measure the SRS to determine which portions of a frequency bandwidth provide the strongest channel quality or conditions for the UE 115. The base station 105 may use these measurements when configuring resources for the UE 115.

In this example, UE 115-a may transmit an SRS in the 9th and 10th symbol periods of the slot (e.g., corresponding to uplink symbols 220), which are scheduled to cause the CLI 225. UE 115-b may receive the SRS (e.g., in the corresponding downlink symbols 220) and perform a measurement procedure using the SRS. UE 115-b may transmit a measurement report to base station 105-b including measurements of the CLI SRS (e.g., reference signal received power (RSRP), received signal strength indicator (RSSI), reference signal received quality (RSRQ)). The configurations for transmitting the CLI SRS at the aggressor UE 115 and receiving and measuring the CLI SRS at the victim UE 115 may be determined and configured at the corresponding serving cells for the aggressor and victim UEs 115. For example, base station 105-a may transmit a first configuration to UE 115-a, and UE 115-a may transmit the SRS based on the configuration. Base station 105-b may transmit a second configuration to UE 115-b, and UE 115-b may monitor for, receive, and measure the CLI SRS based on the second configuration.

The network may use the measurement report to determine whether the UE-to-UE CLI 225 is causing too much performance degradation at UE 115-b or whether UE 115-b can handle more interference. In some cases, the network may determine that UE 115-b can handle more interference from the CLI 225 and implement more aggressive TDD configurations 205 for one or both of the cells. The more aggressive TDD configurations 205 may introduce more overlapping symbols and more CLI 225, but possibly higher throughput. In some cases, the network may determine that the interference from the CLI 225 affects the downlink reception at UE 115-b too much, and the network may implement less aggressive TDD configurations 205 for one or both of the cells. The less aggressive TDD configurations 205 may reduce the number of overlapping symbols and reduce the UE-to-UE CLI 225, which may improve channel conditions for the victim UE 115. In some examples, the determinations may be based on a threshold or a tolerance. For example, if the channel quality, RSRP, RSSI, RSRQ, or another measurement metric, at the victim UE 115 is above a threshold, the serving cell of the victim UE 115 may implement a less aggressive TDD configuration 205. In some cases, one or more of the base stations 105 may make the determination of whether to use a more aggressive or less aggressive TDD configuration 205. Additionally, or alternatively, a control unit (CU), a gNB, or some other entity may make the determination for the one or more TDD configurations 205 based on the measurements.

In some cases, either the victim UE 115 or the aggressor UE 115 may measure the CLI strength. For example, UE 115-b, as the victim, may measure signals transmitted by UE 115-a, the aggressor. Additionally, or alternatively, UE 115-a may measure signals transmitted by UE 115-b. Based on channel reciprocity of the TDD channel, the measurement taken by UE 115-a may also reflect aggressor-to-victim interference strength.

As described herein, the CLI measurement may be RSRP, RSRQ, or RSSI measurements, or a combination of these measurements. RSRP may measure the received reference signal power of a configured reference signal resource. RSSI may indicate the total received power (e.g., including thermal noise, interference, signal strength, etc.) measured in select OFDM symbols. in some cases, the measurements may be based on SRS at different levels. For example, the measurements may be cell-specific, where all UEs 115 in a cell transmit the same SRS. In some cases, the measurements may be group-specific, where a subset of UEs 115 transmit the same SRS. In some examples, the measurements may be UE-specific, where each UE 115 in the cell transmits a distinct SRS unique to the UE 115. This may provide different levels of granularity for determining CLI strength, tolerance, and impact.

In some conventional systems, a UE 115 transmits an SRS to a base station 105. The base station 105 receives the SRS to estimate the uplink channel and accordingly determine an uplink precoding scheme for the UE 115. When a CLI SRS is used for CLI management, a UE 115 may receive the CLI SRS and measure RSRP, RSRQ, RSSI, or a combination of these based on the received CLI SRS. For RSRP measurements, when the CLI SRS is transmitted in an uplink symbol by the aggressor UE 115, reference signal resources may be configured in the corresponding downlink symbol at victim UEs 115. In some cases, a non-zero power (NZP) channel state information (CSI) reference signal (CSI-RS) or CSI interference measurement (CSI-IM) resource may be configured as the measurement resource. In some examples, a zero power CSI-RS resource may be configured for rate matching downlink shared channel (e.g., physical downlink shared channel (PDSCH)) transmissions around the measurement resources. For RSSI measurements, when the CLI SRS is transmitted in an uplink symbol by the aggressor UE 115, the corresponding symbol at one of the victim UEs 115 may be configured as a measurement gap (e.g., converting an uplink symbol to downlink). Therefore, the network may not configure a reference signal resource in that downlink symbol.

In some wireless communications systems, SRS transmission may be restricted to a set of symbols in a slot. For example, some wireless communications systems may only support SRS transmission in the last 6 uplink symbols of a slot and after PUSCH transmission. However, in some TDD configurations, CLI 225 may be scheduled to occur earlier in a slot, such that an aggressor UE 115 may be configured to transmit an SRS outside of the restricted set of symbols. The base stations 105 and UEs 115 described herein may implement techniques to handle transmission of the CLI SRS outside of the restricted set of symbols.

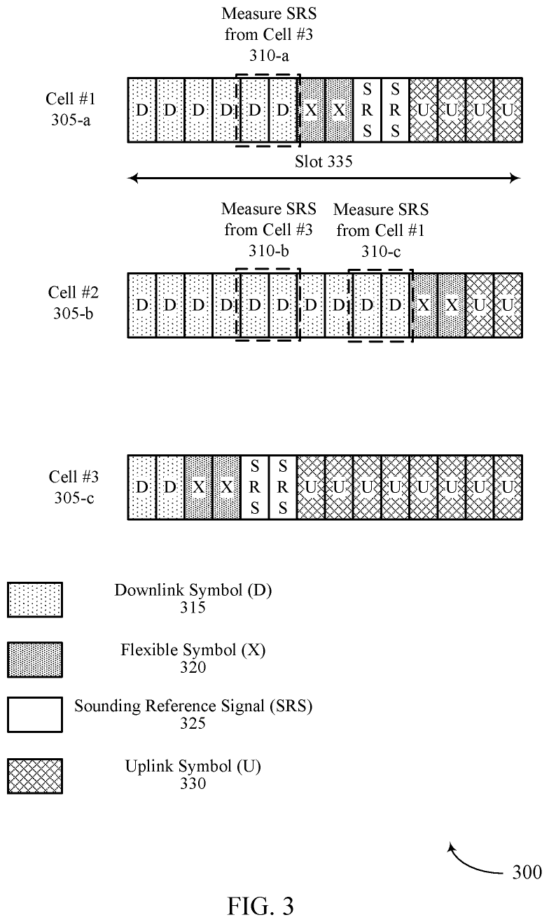

In some cases, an aggressor UE 115 may transmit the CLI SRS in interfering symbols of the uplink/downlink configuration for the dynamic TDD communication, for example regardless of which symbol period in the slot the CLI 225 is expected to occur. The victim UEs 115 in the other cells may perform measurement in the corresponding interfered symbols of the uplink/downlink configuration for the dynamic TDD. An example of this is described in more detail in FIG. 3.

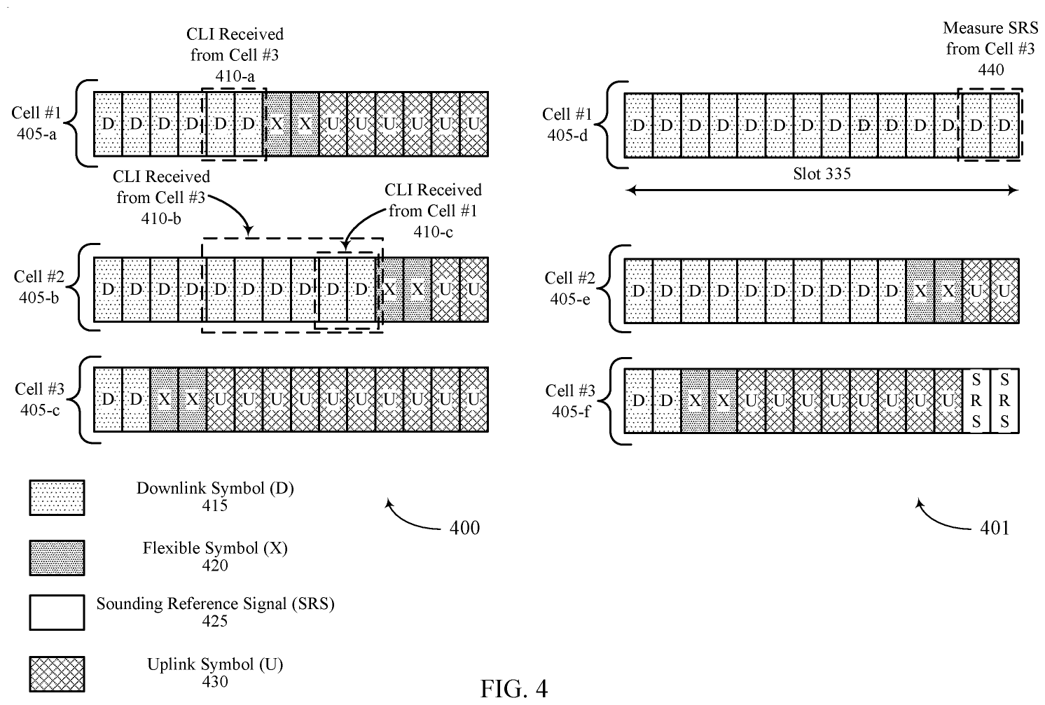

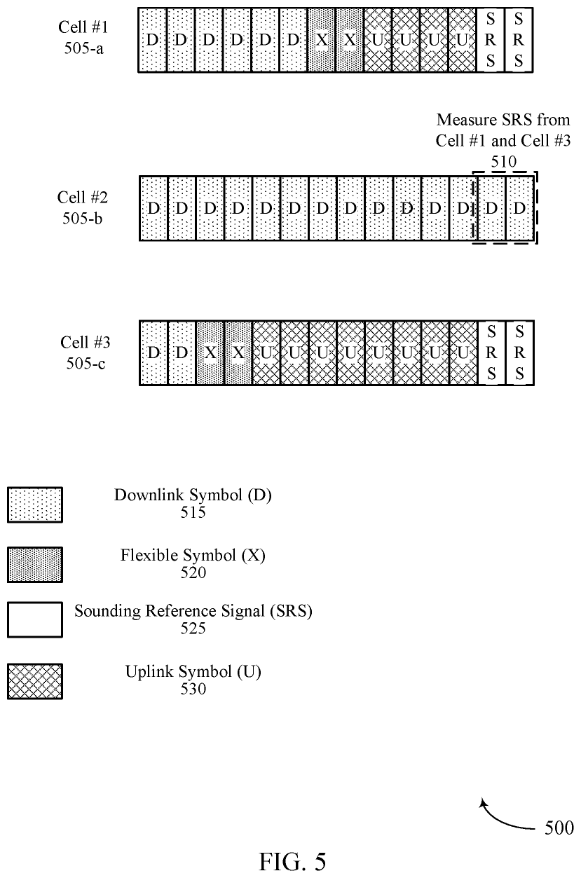

In some cases, the network may configure a separate TDD configuration that is used by the UEs 115 to perform CLI SRS measurement. For example, if the CLI 225 would occur in an early (e.g., outside of the last 6) symbol period of a slot, a dynamically updated TDD configuration may indicate a symbol pattern for the slot which configures the aggressor UE 115 to transmit SRS in one of the last symbol periods of the slot instead. Any victim UEs 115 may then monitor for the SRS according to the dynamically updated TDD configuration and the new symbol pattern. Examples of this are described in more detail in FIGS. 4 and 5.

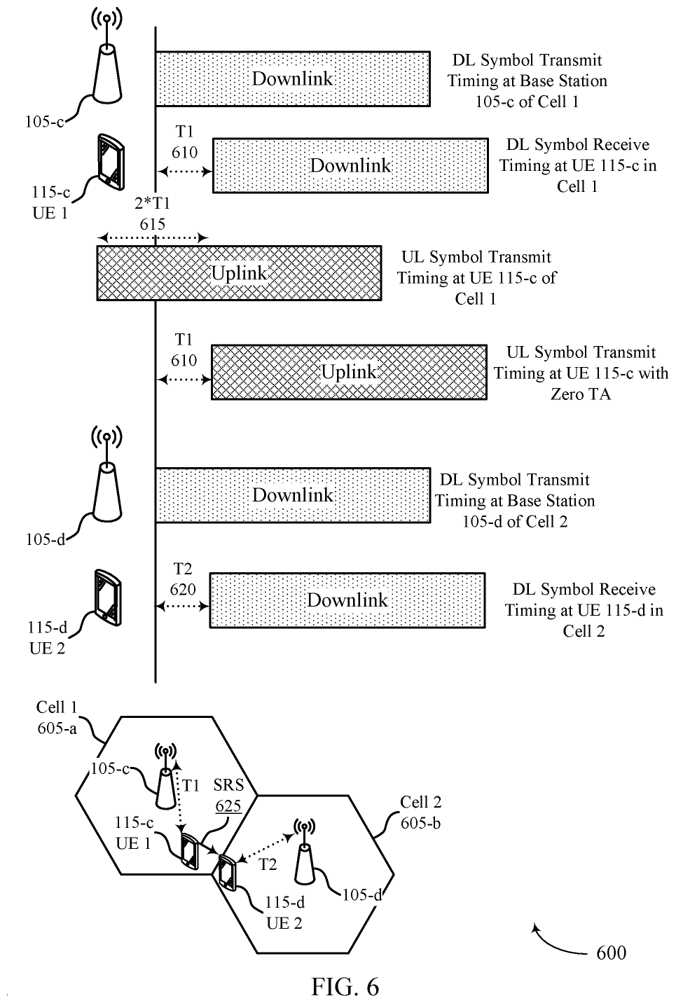

The base stations 105 and UEs 115 may also use a timing advance configuration for the CLI SRS measurements. Timing advance may be used to align the symbol boundary of uplink symbols from different UEs 115 that have different distances to a base station 105. A UE 115 transmitting a CLI SRS may also apply a timing advance when transmitting the CLI SRS for measurement by another UE 115. In some cases, the transmitting UE 115 may apply the same timing advance as regular uplink transmission symbols. In some cases, this may result in inter-symbol interference at the receiving UE 115 if the CLI SRS does not align with the symbol boundary of the downlink symbols of the receiver. In some other examples, the network may statically or dynamically configure a timing advance that makes CLI SRS align with the downlink symbol boundary at the receivers. In some cases, the network may configure the transmitting UEs 115 to apply a zero-valued timing advance to the CLI SRS symbols. When applying a zero-valued timing advance, an aggressor UE 115 transmitting a CLI SRS may not modify the starting transmission time of the CLI SRS. For example, the timing advance may be equal to zero, such that the UE 115 transmits the CLI SRS synchronized with the downlink symbol boundary at the UE 115. Configurations for the timing advance are described in more detail in FIG. 6. In some cases, if the CLI SRS uplink symbol collides with a subsequent uplink symbol at the transmitting UE 115, the transmitting UE 115 may drop the transmission on the subsequent uplink symbol (e.g., to complete transmission of the CLI SRS instead).

Some wireless communications systems may have a configured set of SRS transmission uses. In some cases, these uses may include beam management, codebook, non-codebook, and antenna switching (e.g., {beamManagement, codebook, nonCodebook, antennaSwitching}). A usage indicates how an SRS is transmitted with respect to antenna ports, precoding schemes, symbol pattern, etc. The wireless communication system 200 may utilize a new usage of SRS to indicate the use of SRS for CLI management. In some cases, the new usage may indicate to the UEs 115 a timing advance configuration to use for transmitting the CLI SRS. For example, if the CLI SRS scheme uses a network-configured timing advance or a zero-valued timing advance for CLI SRS transmission, the usage indicator may indicate to the transmitting UE 115 to use one of those timing advances to transmit the CLI SRS.

When CLI SRS is transmitted by a UE 115 that is capable of transmission in multiple uplink beams, the UE 115 may transmit the CLI SRS in one beam or multiple beams. If CLI SRS is transmitted in one beam, the beam may be the serving beam. The serving beam may be the most recently used uplink beam or the currently active beam. If CLI SRS is transmitted in multiple beams, the CLI SRS transmission may follow a time domain pattern of all uplink beams or a subset of all uplink beams. Here, a time domain pattern may include a sequence of uplink symbols where one uplink beam may be activated in each symbol. When CLI SRS is transmitted by a UE that has multiple uplink transmit ports, the UE may transmit the CLI SRS from one port or multiple ports. If CLI SRS is transmitted from one port, the transmit port may correspond to the first port for SRS transmission. The first port for SRS transmission may have a port index 1000. When the CLI SRS is transmitted from multiple ports, the UE may apply a precoding matrix to the CLI SRS that is same as the serving precoding matrix. The serving precoding matrix may be the most recent or currently used uplink precoding matrix for PUSCH.

A resource type for the CLI SRS resource may be aperiodic, semi-persistent, or periodic. In some cases, the CLI SRS may follow a physical uplink shared channel (PUSCH) power control. For example, the CLI SRS transmission may share the same transmit power control (TPC) power loop as PUSCH transmissions. In some cases, the CLI SRS may use an open loop power control. For example, the network may configure an absolute power level for a transmitting UE 115 to use when transmitting a CLI SRS. In some cases, CLI SRS may support SRS frequency domain comb and comb offset.

Frequency comb techniques may be supported for CLI SRS to multiplex multiple CLI SRS resources from the same transmitter or from different transmitters (e.g., different UEs 115). For example, a transmitting UE 115 may apply a frequency comb (e.g., and comb offset) to transmit using interlaced frequency resources. Transmission by different UEs 115 using interlaced frequency resources may allow multiplexing of multiple CLI SRS resources together. The UE 115 receiving the CLI SRS may also be configured for receiving the CLI SRS over interlaced frequency resources (e.g., according to a frequency domain comb and comb offset). If the UE 115 receiving a CLI SRS is configured to take RSRP measurements and CSI-RS is used as the measurement resource, frequency hopping may not be supported (e.g., because CSI-RS does not support frequency hopping). However, if CSI-RS is modified to support frequency hopping or some other resources are configured for CLI SRS measurement, RSRP measurements may support frequency hopping. If the receiving UE 115 is configured to take RSSI measurements, frequency hopping may be configured if the measurement is performed based on time domain sample power at the receiver.

Although illustrated in FIG. 2 as being between UEs served by different cells associated with different base stations, CLI may occur within a single cell. For example, the operations of base station 105-a and base station 105-b may actually be performed by a single base station 105 to manage CLI which occurs within the cell provided by the single base station 105. This may occur based on the single base station 105 configuring different TDD configurations for UEs 115 within the cell (e.g., different TDD configurations for different UEs).

FIG. 3 illustrates an example of a CLI measurement configuration 300 that supports sounding reference signal transmission for UE-to-UE cross-link interference measurement in accordance with aspects of the present disclosure. In some examples, the CLI measurement configuration 300 may implement aspects of wireless communication system 100.

As described in FIG. 2, a wireless communications system may employ multiple cells, where each cell is capable of using a different dynamic TDD configuration. A TDD configuration may include a symbol pattern 305 for a slot 335, including symbol periods for downlink symbols 315, flexible symbols 320, uplink symbols 330, or a combination thereof. A symbol pattern 305 for a TDD configuration for a first cell may be scheduled to cause CLI in at least one other cell. For example, the symbol pattern 305-c for the TDD configuration of cell 3 may be scheduled to cause UE-to-UE CLI in cells 1 and 2. Additionally, the symbol pattern 305-a for the TDD configuration of cell 1 may be scheduled to cause UE-to-UE CLI in cell 2. The aggressor UEs 115 in cells 1 and 3 may be configured to transmit an SRS 325 using a symbol period assigned for the uplink symbols 330 (shown as an SRS 325) which may be scheduled to cause interference.

In the CLI measurement configuration 300, the aggressor UE 115 may transmit the CLI SRS 325 in the interfering symbols of the symbol pattern 305. Even though the SRS transmissions for cell 3 occur outside of the last 6 symbol periods of the slot 335, the aggressor UE 115 in cell 3 may be configured to transmit the SRS 325 in those symbol periods. CLI occurs between uplink symbols 330 (e.g., interfering symbols) of one cell that overlap with downlink symbols 315 (e.g., interfered symbols) of another cell. To ensure CLI SRS is received in downlink symbols 315, aggressor UEs 115 may transmit CLI SRS in the interfering uplink symbols 330. If CLI SRS is transmitted by aggressor UEs 115 in a cell at the beginning of the uplink portion of the slot 335, interfered cells may receive the CLI SRS in downlink symbols 315 at the start of the slot 335. With these techniques, the UEs 115 may use the same TDD configuration and symbol pattern 305 configured for dynamic TDD communications for CLI SRS transmission and measurement. In some examples, the aggressor UEs 115 may not be subject to a restriction of transmitting the SRS 325 in a restricted set of symbols (e.g., corresponding to a last 6 symbol periods of the slot 335 for other types of SRS).

UEs 115 in cell 1 and cell 3 may transmit CLI SRS in the uplink symbols 330 that overlap with their victims. A first base station 105 providing cell 1 may configure victim UEs 115 in cell 1 to monitor for and measure the CLI SRS 325 from the aggressor UEs 115 of cell 3 at 310-a. A second base station 105 providing cell 2 may configure victim UEs 115 of cell 2 to monitor for and measure the CLI SRS 325 from the aggressor UEs 115 of cell 3 at 310-b. A third base station 105 providing cell 3 may configure aggressor UEs 115 of cell 3 to transmit SRS 325 in the interfering uplink symbols 330. Thus, cell 3 CLI SRS may be received by UEs 115 in both cell 1 and 2. The second base station may also configure victim UEs 115 in cell 2 to monitor for and measure the CLI SRS 325 from the aggressor UEs 115 of cell 1 at 310-c. The first base station 105 may configure aggressor UEs 115 in cell 1 to transmit SRS 325 in the interfering uplink symbols 330. Therefore, cell 1 CLI SRS 325 may be received by UEs 115 in cell 2 in this example. UEs 115 in cell 3 may not receive CLI SRS 325 from cell 1, as cell 3 may not be a victim of cell 1. Similarly, cell 2 may not configure its UEs 115 to transmit a CLI SRS 325, as cell 2 may not be an aggressor to any other cell.

FIG. 4 illustrates an example of a dynamic TDD configuration 400 and a CLI measurement configuration 401 that support sounding reference signal transmission for UE-to-UE cross-link interference measurement in accordance with aspects of the present disclosure. In some examples, the TDD configuration 400 and the CLI measurement configuration 401 may implement aspects of wireless communication system 100.

As described herein, a wireless communications system may employ multiple cells, where each cell is capable of using a different dynamic TDD configuration. A dynamic TDD configuration 400 may include a symbol pattern 405 for a slot 435, including symbol periods for downlink symbols 415, flexible symbols 420, uplink symbols 430, or a combination thereof. In this example, the dynamic TDD configuration 400 for each cell may be configured or selected based on traffic flow by the serving base station 105 providing the cell. The serving base station 105 may then dynamically indicate the TDD configuration and symbol pattern 405 to the UEs 115 in the cell.

A symbol pattern 405 for the TDD configuration 400 for a first cell may be scheduled to cause CLI in at least one other cell. For example, the symbol pattern 405-c for the TDD configuration 400 of cell 3 may be scheduled to cause UE-to-UE CLI in cells 1 and 2 at 410-a and 410-b respectively. Additionally, the symbol pattern 405-a for the TDD configuration 400 of cell 1 may be scheduled to cause UE-to-UE CLI in cell 2 at 410-c. In some cases, the aggressor UEs 115 in cells 1 and 3 may be configured to transmit an SRS 425 using a symbol period assigned for the uplink symbols 430 (shown as an SRS 425) which are schedule to cause interference. However, if UEs 115 in the interfering cells are restricted from transmitting an SRS outside of a specific set of symbols (e.g., the last 6 symbols of the slot 435), the UEs 115 in the interfered cells may instead be configured with a CLI SRS measurement configuration 401 to ensure that the SRS 425 is received in a downlink symbol 415.

For example, a first base station 105 providing the first cell may configure cell 1 to a different slot format with symbol pattern 405-d, which may be different from symbol pattern 405-a for the TDD configuration 400. The first base station 105 may configure cell 1 with a slot format to receive CLI SRS transmitted from UEs 115 in cell 3. A third base station in cell 3 may configure UEs 115 in cell 3, aggressor UEs 115, to transmit a CLI SRS 425 in one or more of the last downlink symbols 410 in the slot 435. UEs 115 in cell 1 may then measure the CLI SRS 425 from cell 3 at 440 In some cases, the UEs 115 in cell 1 may mute uplink transmission from UEs 115 in cells other than cell 3. For example, UEs 115 in cell 2 may be muted. In some cases, the base station 105 in cell 2 may mute the UEs 115 in cell 2.

FIG. 5 illustrates an example of a CLI measurement configuration 500 that supports sounding reference signal transmission for UE-to-UE cross-link interference measurement in accordance with aspects of the present disclosure. In some examples, CLI measurement configuration 500 may implement aspects of wireless communication system 100.

As described herein, a wireless communications system may employ multiple cells, where each cell is capable of using a different dynamic TDD configuration. A dynamic TDD configuration may include a symbol pattern 505 for a slot, including symbol periods for downlink symbols 515, flexible symbols 520, uplink symbols 530, or a combination thereof. In this example, the dynamic TDD configuration for each cell may be configured or selected based on traffic flow by the serving base station 105 of the cell. The serving base station 105 may then dynamically indicate the TDD configuration, including the symbol pattern 505, to the UEs 115 in the cell.

A symbol pattern 505 for the TDD configuration for a first cell may be scheduled to cause CLI in at least one other cell. For example, as shown in FIG. 4, a symbol pattern 505 for the TDD configuration of a cell may be scheduled to cause UE-to-UE CLI in other cells. In some cases, the aggressor UEs 115 in the aggressor cells may be configured to transmit an SRS 525 using a symbol period assigned for the uplink symbols 530 which are schedule to cause interference. However, if UEs 115 in the interfering cells are restricted from transmitting an SRS 525 outside of a specific set of symbols (e.g., the last 6 symbols of the slot 435), one or more of the cells may instead use a different TDD configuration to ensure that the SRS 525 is received in a downlink symbol 515.

For example, the CLI measurement configuration 500 may be based on cell 2 from the dynamic TDD configuration 400 of FIG. 4 using an updated dynamic TDD configuration with an updated symbol pattern 505 (e.g., corresponding to symbol pattern 505-b). For example, a second base station 105 providing cell 2 may configure cell 2 to a different slot format to receive CLI SRS 525 transmitted from UEs 115 in cells 1 and 3. If RSSI is measured, either UEs 115 in cell 1 or UEs 115 in cell 3 may transmit the CLI SRS 525 in the same OFDM symbol duration, as the RSSI procedures may not be separately measured if the measurements are done based on a time domain sample power. If RSRP is measured, then both cell 1 and cell 3 may transmit different CLI SRS 525 in the same ODFM symbol duration. The UEs 115 in cell 2 may measure the CLI SRS 525 from cell 1, cell 3, or both, at 510.

FIG. 6 illustrates an example of a timing advance configuration 600 that supports sounding reference signal transmission for UE-to-UE cross-link interference measurement in accordance with aspects of the present disclosure. In some examples, the timing advance configuration 600 may implement aspects of wireless communication system 100. The timing advance configuration 600 may include UE 115-c and UE 115-d, which may each be an example of a UE 115 as described herein. The timing advance configuration 600 also include base station 105-c and base station 105-d, which may each be an example of a base station 105 as described herein. In some cases, base station 105-c and base station 105-d may each be an example of a small cell. The base stations 105 may each be associated with a cell 605 which provides wireless communications with the base station 105 within a coverage area.

As described herein, a wireless communications system may employ multiple cells 605, where each cell 605 is capable of using a different dynamic TDD configuration. A dynamic TDD configuration may include a symbol pattern for a slot, including symbol periods for downlink symbols, flexible symbols, uplink symbols, or a combination thereof some cases, the dynamic TDD configuration for each cell 605 may be configured or selected based on traffic flow by the serving base station 105 of the cell. The serving base station 105 may then dynamically indicate the TDD configuration, including the symbol pattern, to the UEs 115 in the cell 605. In some cases, a symbol pattern for the TDD configuration for a first cell 605 may be scheduled to cause CLI in at least one other cell. For example, a symbol pattern for the TDD configuration of cell 605-a may be scheduled to cause UE-to-UE CLI in cell 605-b. In some cases, the aggressor UEs 115 in the cell 605-a (e.g., UE 115-c) may be configured to transmit a CLI SRS 625 using a symbol period assigned for the uplink symbols which are schedule to cause interference. The victim UEs 115 in the cell 605-b (e.g., UE 115-d) may perform a measurement based on the CLI SRS 625 and report the CLI strength to base station 105-d.

A UE 115 transmitting a CLI SRS 625 may apply a timing advance when transmitting the CLI SRS 625. In some cases, a timing advance may be used to align the symbol boundary of uplink symbols from different UEs 115 that have different distances to a base station 105. A UE 115 transmitting a CLI SRS 625 as described herein may also apply a timing advance when transmitting the CLI SRS 625 for measurement by another UE 115.

In some cases, UE 115-c may apply the same timing advance as regular uplink transmission symbols, referred to here as an uplink timing advance 615. When base station 105-c transmits a downlink symbol to UE 115-c, UE 115-c may identify the duration T1 elapsed from the downlink symbol edge to when UE 115-c actually receives the downlink symbol. This may correspond to a propagation delay 610 for the signal to be carried over a wireless medium from base station 105-c to UE 115-c. Thus, the propagation delay 610 may be equal to the difference between the downlink symbol transmit timing at base station 105-c and the downlink symbol receive timing at UE 115-c. The uplink timing advance 615 may be equal to, or subject to a constant bias, twice the propagation delay 610, or 2*T1, which may be the referred to as the round trip delay between UE 115-c and base station 105-c. Therefore, in some cases, UE 115-c may transmit the CLI SRS 625 by applying the uplink timing advance 615. In some cases, applying the uplink timing advance 615 may result in inter-symbol interference at UE 115-d if the CLI SRS 625 does not align with the symbol boundary of the downlink symbols of UE 115-d. However, this technique may reduce complexity for UE 115-c.

In some other examples, the network may statically or dynamically configure a timing advance that makes CLI SRS align with the downlink symbol boundary at the receivers. For example, base station 105-c may transmit a configuration to UE 115-c including a value for the timing advance to use for the CLI SRS 625.

In some cases, base station 105-c may configure UEs 115 in cell 605-a (e.g., including UE 115-c) to apply a zero-valued timing advance to the CLI SRS 625. When applying a zero-valued timing advance, an aggressor UE 115 transmitting a CLI SRS 625, such as UE 115-c, may not modify the starting transmission time of the CLI SRS 625. For example, the timing advance may be equal to zero, such that UE 115-c transmits the CLI SRS 625 approximately at the perceived start of its downlink symbol boundary. In some cases, if the uplink symbol carrying the CLI SRS 625 collides with a subsequent uplink symbol at UE 115-c, UE 115-c may drop the transmission on the subsequent uplink symbol (e.g., to transmit the CLI SRS 625 instead).

In some cases, applying a zero-valued timing advance may be appropriate based on the propagation delay 610 between base station 105-c and UE 115-c being similar to a propagation delay 620 between base station 105-d and UE 115-d. In some cases, the channel delay to a gNB (e.g., T1 and T2) may be roughly the same for a UE 115 at an edge of a cell 605. Therefore, both UE 115-c and UE 115-d may have a similar propagation delay. In some cases, distance between UE 115-c and UE 115-d may be negligible, such that the UEs 115 do not have to consider additional propagation delay between themselves.

In any of the examples described in FIGS. 3 through 6, the first base station 105 and the second base station 105 may, in some cases, be a same base station 105. For example, a base station 105 may implement the techniques described herein to manage CLI within a cell (e.g., intra-cell CLI). The base station 105 may configure a first UE 115 with a first TDD configuration and configure a second UE 115 with a second TDD configuration, where the first UE 115 and the second UE 115 are in the same cell. The first TDD configuration and the second TDD configuration may, in some cases, lead to CLI in the cell. The base station 105 may then configure the aggressor UE 115 to transmit a CLI measurement signal (e.g., an SRS) as described herein, and the base station 105 may configure the victim UE 115 to measure the CLI measurement signal (e.g., the SRS) as described herein. Thus, a single base station 105 may also implement the techniques described for a first and second base station 105 in order to manage CLI within a single cell.

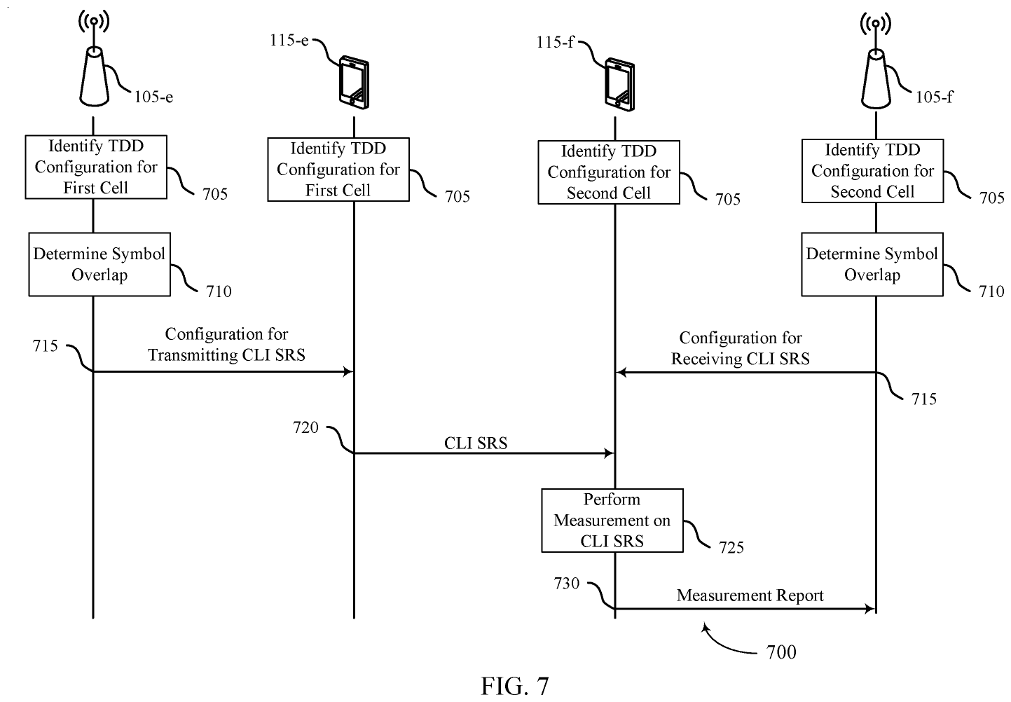

FIG. 7 illustrates an example of a process flow 700 that supports sounding reference signal transmission for UE-to-UE cross-link interference measurement in accordance with aspects of the present disclosure. In some examples, the process flow 700 may implement aspects of wireless communication system 100. The process flow 700 may include UE 115-e and UE 115-f, which may each be an example of a UE 115 as described herein. The process flow 700 also include base station 105-e and base station 105-f, which may each be an example of a base station 105 as described herein. In some cases, base station 105-e and base station 105-f may each be an example of a small cell. The base stations 105 may each be associated with a cell which provides wireless communications with the base station 105 within a coverage area. UE 115-e may be served by a first cell associated with base station 105-e. UE 115-f may be served by a second cell associated with base station 105-f. Alternative examples of the following may be implemented, where some steps are performed in a different order than described or are not performed at all. In some cases, steps may include additional features not mentioned below, or further steps may be added.

At 705, UE 115-e may identify a TDD configuration for the first cell, where the TDD configuration includes a symbol pattern for a slot of a set of slots. UE 115-f may identify a TDD configuration for the second cell, where the TDD configuration includes a symbol pattern for the slot of the set of slots. Base station 105-e may identify a first TDD configuration for the first cell of base station 105-e, where the first TDD configuration includes a first symbol pattern for the first cell for the slot. Base station 105-f may identify a second TDD configuration for the second cell of base station 105-f, where the second TDD configuration includes a second symbol pattern for the second cell for the slot.

At 710, the base stations 105 (e.g., base station 105-e and base station 105-f) may determine an overlap between a downlink symbol or a flexible symbol and an uplink symbol during one or more symbols of the slot based on first TDD configuration of the cell and the second TDD configuration of the second cell.

At 715, base station 105-e may transmit a first configuration to UE 115-e for transmitting a CLI SRS in the slot based on the overlap, where the CLI SRS is configured for transmission in a downlink symbol or a flexible symbol of the second symbol pattern for the slot. In some examples, the first configuration includes a timing advance for the CLI SRS that is different from a timing advance for uplink shared channel transmissions for UE 115-e. In some cases, the timing advance for the CLI SRS may be a zero-valued timing advance. In some examples, the first configuration may include an open loop power control parameter for the CLI SRS. In some cases, base station 105-e may configure the CLI SRS to be transmitted aperiodically, semi-persistently, or periodically.

Base station 105-f may transmit a second configuration to UE 115-f for performing a measurement of a CLI SRS in the slot based on the overlap, where the CLI SRS is configured to be transmitted by UE 115-e served by base station 105-e. In some cases, base station 105-f may configure UE 115-f to perform the measurement of the CLI SRS aperiodically, semi-persistently, or periodically. In some examples, the base stations 105 may transmit an indicator that a NZP CSI-RS resource or a CSI-IM is configured as a measurement resource for the CLI SRS. In some cases, base station 105-f may configure UE 115-f to transmit the CLI SRS such that UE 115-f is not subject to a restriction for SRS transmission as described in FIG. 3.

In some cases, base station 105-f may determine a third symbol pattern for the second cell for the slot and transmit an indicator for the third symbol pattern for the slot to UE 115-f. UE 115-f may identify a third TDD configuration for the second cell including the third symbol pattern for the slot based on the second configuration for receiving the CLI SRS in the slot. For example, base station 105-f may configure UE 115-f with a different TDD configuration and symbol pattern as described in FIGS. 4 and 5.

At 720, UE 115-e may transmit, to UE 115-f, the CLI SRS in the slot according to the first configuration. In some cases, UE 115-e may apply a timing advance to transmit the CLI SRS as described herein. For example, UE 115-e may apply a zero-valued timing advance as described in FIG. 6. UE 115-f may perform a measurement on the CLI SRS in the slot based on the second TDD configuration at 725. At 730, UE 115-f may report the measurement for the CLI SRS to base station 105-f.

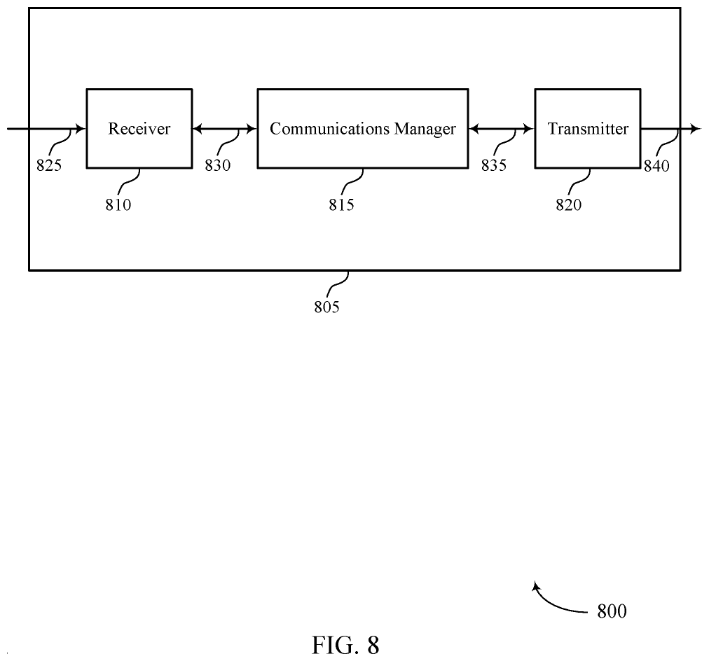

FIG. 8 shows a block diagram 800 of a device 805 that supports sounding reference signal transmission for UE-to-UE cross-link interference measurement in accordance with aspects of the present disclosure. The device 805 may be an example of aspects of a UE 115 as described herein. The device 805 may include a receiver 810, a communications manager 815, and a transmitter 820. The device 805 may also include a processor. Each of these components may be in communication with one another (e.g., via one or more buses).

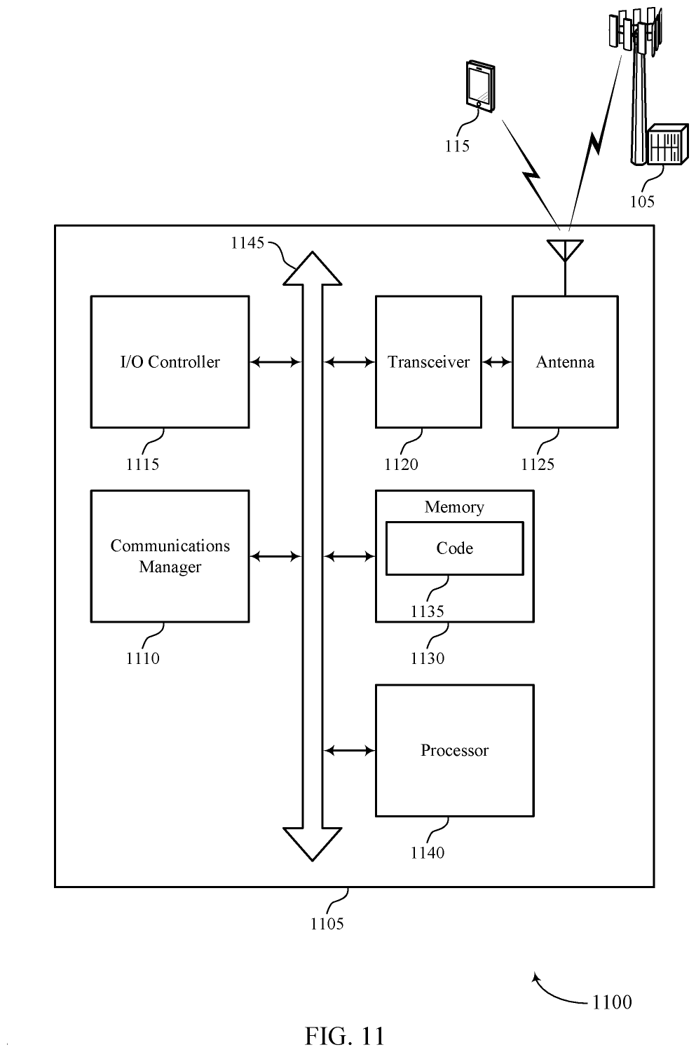

The receiver 810 may receive information 825 such as packets, user data, or control information associated with various information channels (e.g., control channels, data channels, and information related to sounding reference signal transmission for UE-to-UE cross-link interference measurement, etc.). Information 830 may be passed on to other components of the device 805. The receiver 810 may be an example of aspects of the transceiver 1120 described with reference to FIG. 11. The receiver 810 may utilize a single antenna or a set of antennas.

The communications manager 815 may identify a TDD configuration for the cell, where the TDD configuration includes a symbol pattern for a slot of a set of slots, receive a configuration for transmitting a CLI SRS in the slot, and transmit, to a second UE served by a second cell associated with a second base station, the CLI SRS in the slot according to the configuration. The communications manager 815 may also identify a TDD configuration for the cell, where the TDD configuration includes a symbol pattern for a slot of a set of slots, receive a configuration for receiving a CLI SRS in the slot, where the CLI SRS is transmitted by a second UE served by a second cell associated with a second base station, and perform a measurement on the CLI SRS in the slot based on the TDD configuration. In some cases, some operations of the communications manager 815 may be based on information 830 received from the receiver 810. For example, the information 830 may include the configuration for transmitting the CLI SRS in the slot or include the configuration for receiving the CSLI SRS in the slot. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals 840 generated by other components of the device 805. The transmitter 820 may transmit the signals 840 based on information 835 received from the communications manager 815. For example, the transmitter signals 840 may include a CLI SRS, which may be prepared for transmission based on the information 835. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

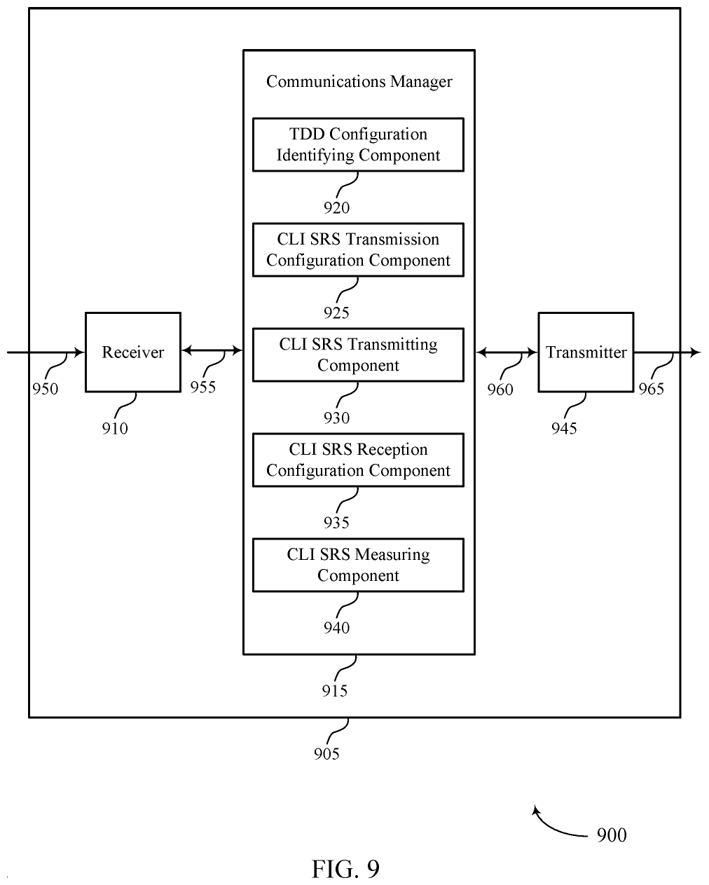

FIG. 9 shows a block diagram 900 of a device 905 that supports sounding reference signal transmission for UE-to-UE cross-link interference measurement in accordance with aspects of the present disclosure. The device 905 may be an example of aspects of a device 805, or a UE 115 as described herein. The device 905 may include a receiver 910, a communications manager 915, and a transmitter 945. The device 905 may also include a processor. Each of these components may be in communication with one another (e.g., via one or more buses).

The receiver 910 may receive information 950 such as packets, user data, or control information associated with various information channels (e.g., control channels, data channels, and information related to sounding reference signal transmission for UE-to-UE cross-link interference measurement, etc.). Information 955 may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a TDD configuration identifying component 920, a CLI SRS transmission configuration component 925, a CLI SRS transmitting component 930, a CLI SRS reception configuration component 935, and a CLI SRS measuring component 940. The communications manager 915 may be an example of aspects of the communications manager 1110 described herein.

The TDD configuration identifying component 920 may identify a TDD configuration for the cell, where the TDD configuration includes a symbol pattern for a slot of a set of slots. The CLI SRS transmission configuration component 925 may receive a configuration for transmitting a CLI SRS in the slot. The CLI SRS transmitting component 930 may transmit, to a second UE, the CLI SRS in the slot according to the configuration.

The TDD configuration identifying component 920 may identify a TDD configuration for the cell, where the TDD configuration includes a symbol pattern for a slot of a set of slots. The CLI SRS reception configuration component 935 may receive a configuration for receiving a CLI SRS in the slot, where the CLI SRS is transmitted by a second UE served. The CLI SRS measuring component 940 may perform a measurement on the CLI SRS in the slot based on the TDD configuration.

In some cases, some operations of the communications manager 915 may be based on information 955 received from the receiver 910. For example, the information 955 may include the configuration for transmitting the CLI SRS in the slot or include the configuration for receiving the CSLI SRS in the slot.

The transmitter 945 may transmit signals generated by other components of the device 905. In some examples, the transmitter 945 may be collocated with a receiver 910 in a transceiver module. For example, the transmitter 945 may be an example of aspects of the transceiver 1120 described with reference to FIG. 11. The transmitter 945 may utilize a single antenna or a set of antennas. The transmitter 945 may transmit signals 965 based on information 960 received from the communications manager 915. For example, the transmitter signals 965 may include a CLI SRS, which may be prepared for transmission based on the information 960.

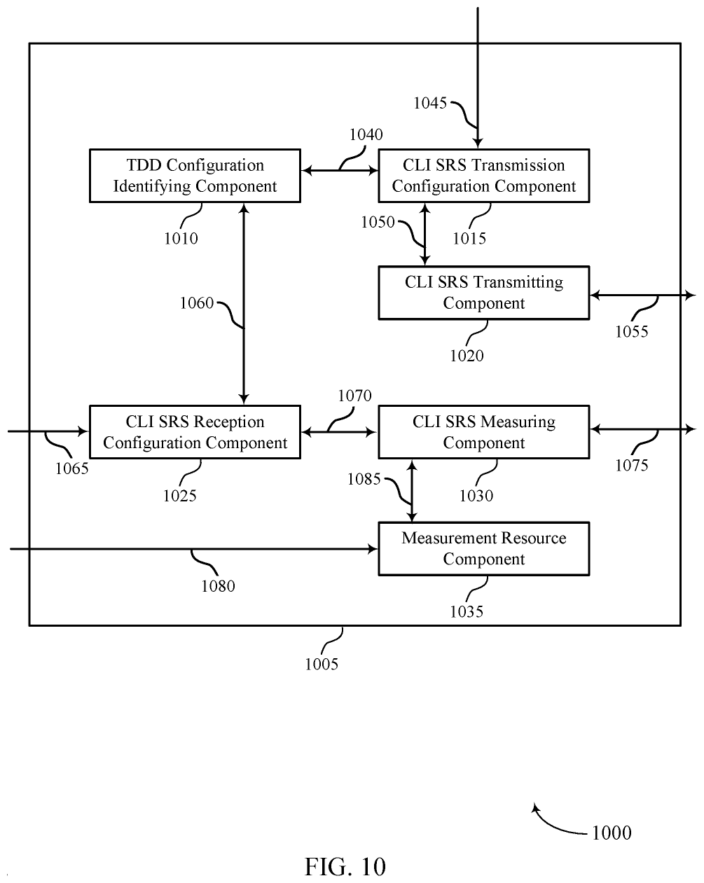

FIG. 10 shows a block diagram 1000 of a communications manager 1005 that supports sounding reference signal transmission for UE-to-UE cross-link interference measurement in accordance with aspects of the present disclosure. The communications manager 1005 may be an example of aspects of a communications manager 815, a communications manager 915, or a communications manager 1110 described herein. The communications manager 1005 may include a TDD configuration identifying component 1010, a CLI SRS transmission configuration component 1015, a CLI SRS transmitting component 1020, a CLI SRS reception configuration component 1025, a CLI SRS measuring component 1030, and a measurement resource component 1035. Each of these modules may communicate, directly or indirectly, with one another (e.g., via one or more buses).

The TDD configuration identifying component 1010 may identify a TDD configuration for a first UE, where the TDD configuration includes a symbol pattern for a slot of a set of slots. In some examples, the TDD configuration identifying component 1010 may identify a second TDD configuration for a second UE including a second symbol pattern for the slot based on the configuration for receiving the CLI SRS in the slot. In some examples, the TDD configuration identifying component 1010 may perform the measurement on the CLI SRS in the slot based on the second symbol pattern for the slot. In some cases, the first UE is served by a first cell of a first base station and the second UE is served by a second cell of a second, different base station. In some cases, the first UE and second UEs are served by a same cell. In some cases, a first symbol of the slot is configured as an uplink symbol in the symbol pattern for the slot, the first symbol of the slot is configured as a flexible symbol or a downlink symbol in the second symbol pattern for the slot, and the CLI SRS is received during the first symbol.

The CLI SRS transmission configuration component 1015 may receive a configuration 1045 for transmitting a CLI SRS in the slot. In some examples, the CLI SRS transmission configuration component 1015 may receive a second configuration for transmitting a second SRS, the second configuration configuring the second SRS according to one or more of a first set of symbols of the set of slots subject to a restriction, where the first configuration configures the CLI SRS for transmission according to one or more of a second set of symbols of the slot not subject to the restriction. In some cases, the TDD configuration identifying component 1010 may send a TDD configuration 1040 to the CLI SRS transmission configuration component 1015.

In some cases, a transmit power for the CLI SRS is based on a TPC loop for physical uplink shared channel transmissions. In some cases, a transmit power for the CLI SRS is based on an open loop power control parameter for the CLI SRS. In some cases, the open loop power control parameter includes a fixed power level for CLI SRS transmissions. In some cases, the CLI SRS is configured to be transmitted aperiodically, semi-persistently, or periodically. In some cases, the CLI SRS is configured to be transmitted according to interlaced frequency resources, using a code of a set of orthogonal codes, according to a frequency hopping pattern, or a combination thereof.

The CLI SRS transmitting component 1020 may transmit, to a second UE, the CLI SRS in the slot according to the configuration. In some cases, the CLI SRS may be transmitted in a signal 1055. In some examples, the CLI SRS transmitting component 1020 may determine that an uplink transmission during an uplink symbol period subsequent to the CLI SRS transmission is scheduled to collide with the CLI SRS transmission based on the timing advance for the CLI SRS and the timing advance for uplink shared channel transmissions. In some examples, the CLI SRS may be transmitted based on configuration information 1050 received from the CLI SRS transmission configuration component 1015. The configuration information 1050 may be based on the TDD configuration 1040 and the configuration 1045 received at the CSI SRS transmission configuration component 1015.

In some examples, the CLI SRS transmitting component 1020 may drop the uplink transmission from the uplink symbol period. In some examples, the CLI SRS transmitting component 1020 may receive the timing advance for the CLI SRS from the base station. In some cases, the transmitting the CLI SRS applies a timing advance for uplink shared channel transmissions. In some cases, the transmitting the CLI SRS applies a timing advance for the CLI SRS that is different from a timing advance for uplink shared channel transmissions. In some cases, the timing advance for the CLI SRS is a zero-valued timing advance. In some cases, the CLI SRS may be transmitted on multiple beams corresponding to multiple of transmit ports. In some cases, the CLI SRS transmitting component 1020 may apply a precoding matrix to the CLI SRS transmission corresponding to a serving precoding matrix.

The CLI SRS reception configuration component 1025 may receive a configuration for receiving a CLI SRS in the slot, where the CLI SRS is transmitted by a second UE. In some cases, the TDD configuration identifying component 1010 may send a TDD configuration 1060 to the CLI SRS reception configuration component 1025. In some cases, the CLI SRS is configured to be transmitted according to interlaced frequency resources, using a code of a set of orthogonal codes, according to a frequency hopping pattern, or a combination thereof.

The CLI SRS measuring component 1030 may perform a measurement on the CLI SRS in the slot based on the TDD configuration. In some cases, the CLI SRS measuring component 1030 may perform the measurements based on a configuration 1070 received from the CLI SRS reception configuration component 1025. In some examples, the CLI SRS measuring component 1030 may report the measurement for the CLI SRS to the base station. In some examples, the measurement for the CLI SRS may be transmitted in a signal 1075 to a base station 105. In some cases, the measurement is an RSSI measurement or an RSRP measurement. In some cases, the measurement for the CLI SRS is configured to be performed aperiodically, semi-persistently, or periodically.

The measurement resource component 1035 may receive an indicator 1080 that a NZP CSI-RS resource or a CSI-IM is configured as a measurement resource for the CLI SRS. In some examples, the measurement resource component 1035 may receive an indicator that at least a portion of a zero power CSI-RS resource is configured for rate matching a PDSCH transmission around the measurement resource for the CLI SRS. In some cases, the measurement resource component 1035 may send a measurement resource component indication 1085 to the CLI SRS measuring component 1030, and the CLI SRS measuring component 1030 may measure the CLI SRS based on the measurement resource component indication 1085.

FIG. 11 shows a diagram of a system 1100 including a device 1105 that supports sounding reference signal transmission for UE-to-UE cross-link interference measurement in accordance with aspects of the present disclosure. The device 1105 may be an example of or include the components of device 805, device 905, or a UE 115 as described herein. The device 1105 may include components for bi-directional voice and data communications including components for transmitting and receiving communications, including a communications manager 1110, an I/O controller 1115, a transceiver 1120, an antenna 1125, memory 1130, and a processor 1140. These components may be in electronic communication via one or more buses (e.g., bus 1145).

The communications manager 1110 may identify a TDD configuration, where the TDD configuration includes a symbol pattern for a slot of a set of slots, receive a configuration for transmitting a CLI SRS in the slot, and transmit, to a second UE, the CLI SRS in the slot according to the configuration. The communications manager 1110 may also identify a TDD configuration, where the TDD configuration includes a symbol pattern for a slot of a set of slots, receive a configuration for receiving a CLI SRS in the slot, where the CLI SRS is transmitted by a second UE, and perform a measurement on the CLI SRS in the slot based on the TDD configuration.

The I/O controller 1115 may manage input and output signals for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The transceiver 1120 may communicate bi-directionally, via one or more antennas, wired, or wireless links as described above. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM and ROM. The memory 1130 may store computer-readable, computer-executable code 1135 including instructions that, when executed, cause the processor to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting sounding reference signal transmission for UE-to-UE cross-link interference measurement).

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

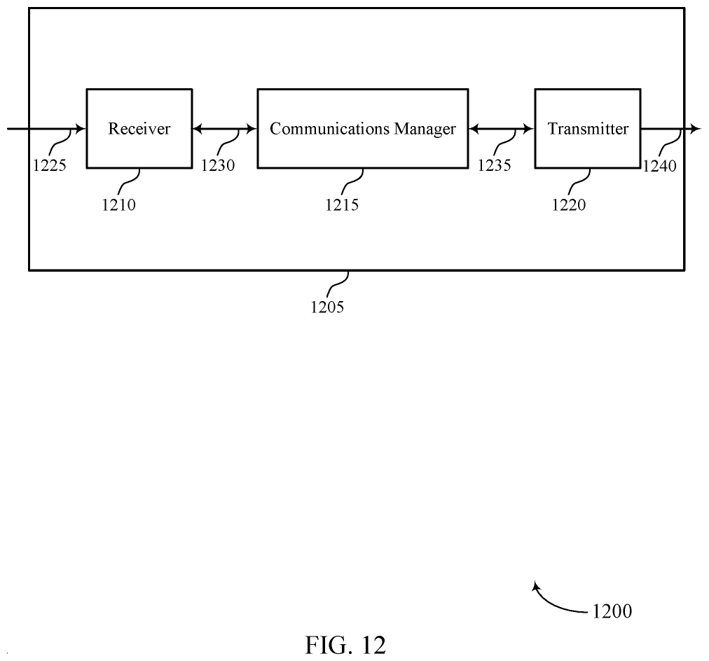

FIG. 12 shows a block diagram 1200 of a device 1205 that supports sounding reference signal transmission for UE-to-UE cross-link interference measurement in accordance with aspects of the present disclosure. The device 1205 may be an example of aspects of a base station 105 as described herein. The device 1205 may include a receiver 1210, a communications manager 1215, and a transmitter 1220. The device 1205 may also include a processor. Each of these components may be in communication with one another (e.g., via one or more buses).

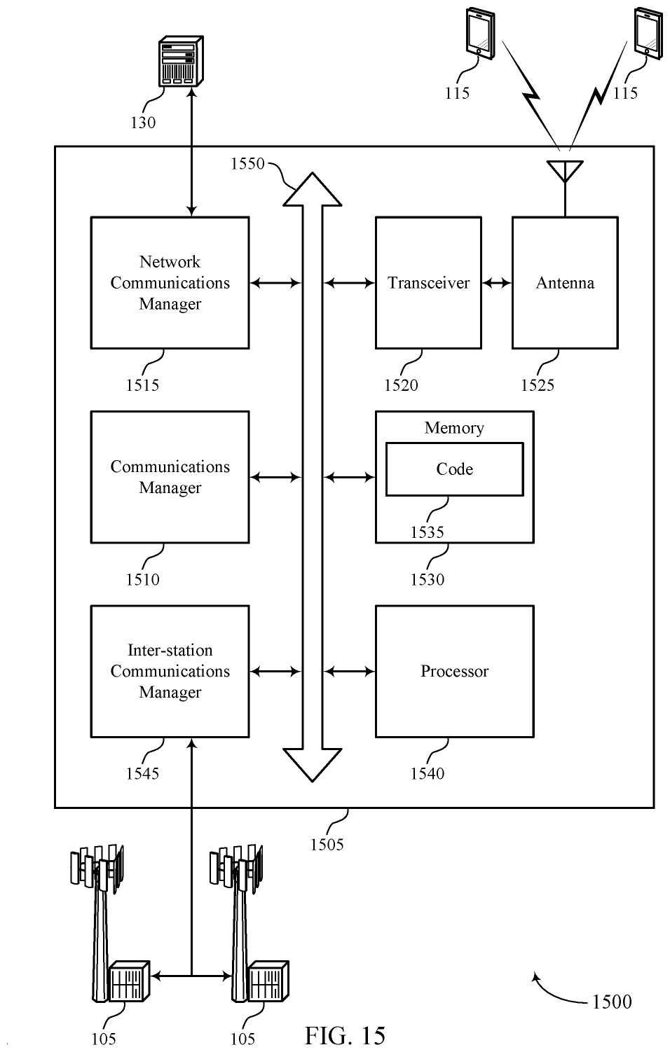

The receiver 1210 may receive information 1225 such as packets, user data, or control information associated with various information channels (e.g., control channels, data channels, and information related to sounding reference signal transmission for UE-to-UE cross-link interference measurement, etc.). Information 1230 may be passed on to other components of the device 1205. The receiver 1210 may be an example of aspects of the transceiver 1520 described with reference to FIG. 15. The receiver 1210 may utilize a single antenna or a set of antennas.

The communications manager 1215 may identify a first TDD configuration for a first UE, where the first TDD configuration includes a first symbol pattern for the first cell for a slot of a set of slots, determine an overlap between a downlink symbol or a flexible symbol and an uplink symbol during one or more symbols of the slot based on a second TDD configuration for a second UE, where the second TDD configuration includes a second symbol pattern for the slot of the set of slots, and transmit a configuration to the first UE for transmitting a CLI SRS in the slot based on the overlap, where the CLI SRS is configured for transmission in a downlink symbol or a flexible symbol of the second symbol pattern for the slot. In some cases, the first UE is served by a first cell of a first base station (e.g., comprising the communications manager 1215) and the second UE is served by a second cell of a second, different base station. In some cases, the first UE and second UEs are served by a same cell.

The communications manager 1215 may also identify a first TDD configuration for a first UE, where the first TDD configuration includes a first symbol pattern for the first cell for a slot of a set of slots, determine an overlap between a downlink symbol or a flexible symbol and an uplink symbol during one or more symbols of the slot based on a second TDD configuration for a second UE, where the second TDD configuration includes a second symbol pattern for the slot of the set of slots, transmit a configuration to a first UE for performing a measurement of a CLI SRS in the slot based on the overlap, where the CLI SRS is configured to be transmitted by the second UE, and receive, from the first UE, a report including the measurement based on the CLI SRS. In some cases, some operations of the communications manager 1215 may be based on information 1230 received from the receiver 1210. For example, the information 1230 may include the configuration for receiving or measuring the CLI SRS in the slot. The communications manager 1215 may be an example of aspects of the communications manager 1510 described herein. In some cases, the first UE is served by a first cell of a first base station (e.g., comprising the communications manager 1215) and the second UE is served by a second cell of a second, different base station. In some cases, the first UE and second UEs are served by a same cell.

The communications manager 1215, or its sub-components, may be implemented in hardware, code (e.g., software or firmware) executed by a processor, or any combination thereof. If implemented in code executed by a processor, the functions of the communications manager 1215, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1215, or its sub-components, may be physically located at various positions, including being distributed such that portions of functions are implemented at different physical locations by one or more physical components. In some examples, the communications manager 1215, or its sub-components, may be a separate and distinct component in accordance with various aspects of the present disclosure. In some examples, the communications manager 1215, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1220 may transmit signals 1240 generated by other components of the device 1205. The transmitter 1220 may transmit the signals 1240 based on information 1235 received from the communications manager 1215. For example, the transmitter signals 1240 may include a CLI SRS, which may be prepared for transmission based on the information 1235. In some examples, the transmitter 1220 may be collocated with a receiver 1210 in a transceiver module. For example, the transmitter 1220 may be an example of aspects of the transceiver 1520 described with reference to FIG. 15. The transmitter 1220 may utilize a single antenna or a set of antennas.

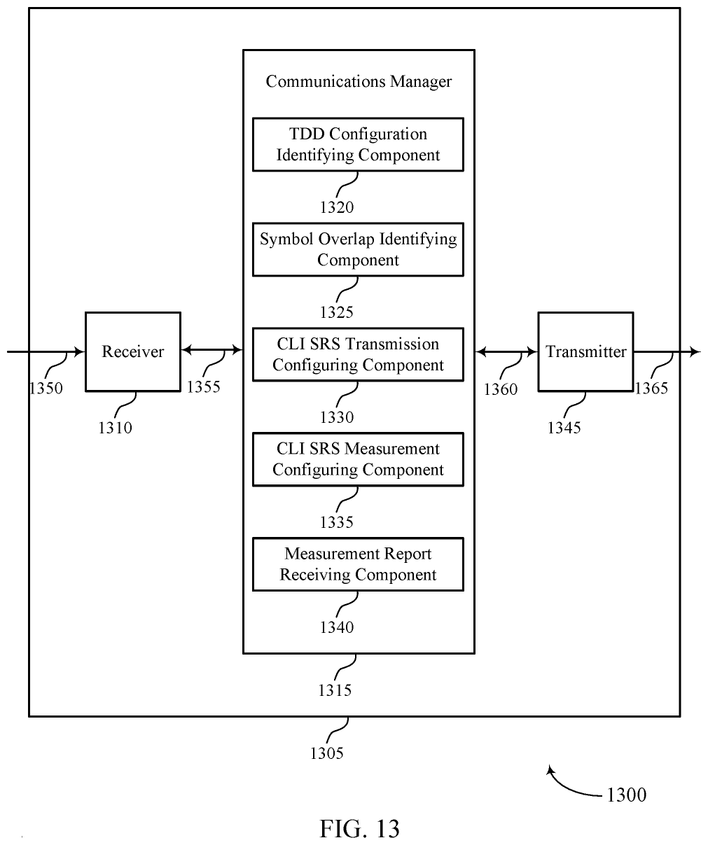

FIG. 13 shows a block diagram 1300 of a device 1305 that supports sounding reference signal transmission for UE-to-UE cross-link interference measurement in accordance with aspects of the present disclosure. The device 1305 may be an example of aspects of a device 1205, or a base station 105 as described herein. The device 1305 may include a receiver 1310, a communications manager 1315, and a transmitter 1345. The device 1305 may also include a processor. Each of these components may be in communication with one another (e.g., via one or more buses).

The receiver 1310 may receive information 1350 such as packets, user data, or control information associated with various information channels (e.g., control channels, data channels, and information related to sounding reference signal transmission for UE-to-UE cross-link interference measurement, etc.). Information 1355 may be passed on to other components of the device 1305. The receiver 1310 may be an example of aspects of the transceiver 1520 described with reference to FIG. 15. The receiver 1310 may utilize a single antenna or a set of antennas.

The communications manager 1315 may be an example of aspects of the communications manager 1215 as described herein. The communications manager 1315 may include a TDD configuration identifying component 1320, a symbol overlap identifying component 1325, a CLI SRS transmission configuring component 1330, a CLI SRS measurement configuring component 1335, and a measurement report receiving component 1340. The communications manager 1315 may be an example of aspects of the communications manager 1510 described herein.

The TDD configuration identifying component 1320 may identify a first TDD configuration for a first UE, where the first TDD configuration includes a first symbol pattern for the first UE for a slot of a set of slots. The symbol overlap identifying component 1325 may determine an overlap between a downlink symbol or a flexible symbol and an uplink symbol during one or more symbols of the slot based on a second TDD configuration for a second UE, where the second TDD configuration includes a second symbol pattern for the second UE for the slot of the set of slots. The CLI SRS transmission configuring component 1330 may transmit a configuration to the first UE for transmitting a CLI SRS in the slot based on the overlap, where the CLI SRS is configured for transmission in a downlink symbol or a flexible symbol of the second symbol pattern for the slot. In some cases, the first UE is served by a first cell of a first base station (e.g., comprising the TDD configuration identifying component 1320) and the second UE is served by a second cell of a second, different base station. In some cases, the first UE and second UEs are served by a same cell.

The TDD configuration identifying component 1320 may identify a first TDD configuration for a first UE, where the first TDD configuration includes a first symbol pattern for the first UE for a slot of a set of slots. The symbol overlap identifying component 1325 may determine an overlap between a downlink symbol or a flexible symbol and an uplink symbol during one or more symbols of the slot based on a second TDD configuration for a second UE, where the second TDD configuration includes a second symbol pattern for the second UE for the slot of the set of slots. The CLI SRS measurement configuring component 1335 may transmit a configuration to a first UE served by the base station for performing a measurement of a CLI SRS in the slot based on the overlap, where the CLI SRS is configured to be transmitted by a second UE. The measurement report receiving component 1340 may receive, from the first UE, a report including the measurement based on the CLI SRS. In some cases, the first UE is served by a first cell of a first base station (e.g., comprising the TDD configuration identifying component 1320) and the second UE is served by a second cell of a second, different base station. In some cases, the first UE and second UEs are served by a same cell.

In some cases, some operations of the communications manager 1315 may be based on information 1355 received from the receiver 1310. For example, the information 1355 may include the configuration for transmitting or the configuration for measuring the CLI SRS.

The transmitter 1345 may transmit signals generated by other components of the device 1305. In some examples, the transmitter 1345 may be collocated with a receiver 1310 in a transceiver module. For example, the transmitter 1345 may be an example of aspects of the transceiver 1520 described with reference to FIG. 15. The transmitter 1345 may utilize a single antenna or a set of antennas. The transmitter 1345 may transmit signals 1365 based on information 1360 received from the communications manager 1315. For example, the transmitter signals 1365 may include a CLI SRS configuration, which may be prepared for transmission based on the information 1360.

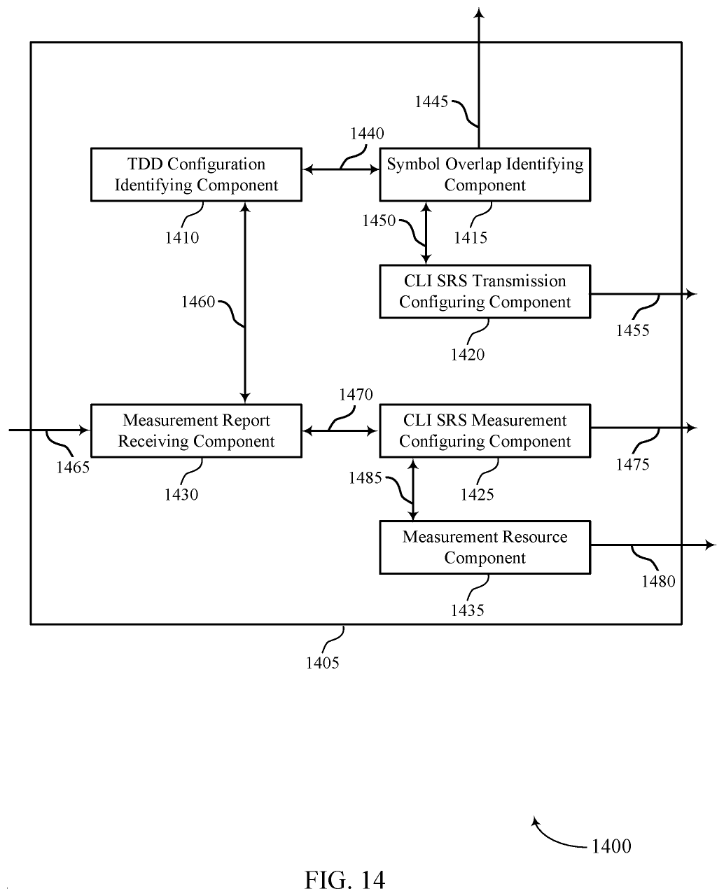

FIG. 14 shows a block diagram 1400 of a communications manager 1405 that supports sounding reference signal transmission for UE-to-UE cross-link interference measurement in accordance with aspects of the present disclosure. The communications manager 1405 may be an example of aspects of a communications manager 1215, a communications manager 1315, or a communications manager 1510 described herein. The communications manager 1405 may include a TDD configuration identifying component 1410, a symbol overlap identifying component 1415, a CLI SRS transmission configuring component 1420, a CLI SRS measurement configuring component 1425, a measurement report receiving component 1430, and a measurement resource component 1435. Each of these modules may communicate, directly or indirectly, with one another (e.g., via one or more buses).

The TDD configuration identifying component 1410 may identify a first TDD configuration for a first UE, where the first TDD configuration includes a first symbol pattern for the first UE for a slot of a set of slots. In some cases, the base station serves the first UE via a first cell and the second UE is served by a second cell of a second, different base station. In some cases, the base station serves the first UE and the second UE via a same cell. In some examples, the TDD configuration identifying component 1410 may send a TDD configuration message 1440 to the symbol overlap identifying component 1415.

In some examples, the TDD configuration identifying component 1410 may determine a third symbol pattern for the first UE for the slot. In some examples, the TDD configuration identifying component 1410 may transmit an indicator 1445 for the third symbol pattern for the slot to the first UE. In some cases, a first symbol of the slot is configured as an uplink symbol in the first symbol pattern for the slot, the first symbol of the slot is configured as a flexible symbol or a downlink symbol in the third symbol pattern for the slot, and the CLI SRS is transmitted by the second UE during the first symbol.

The symbol overlap identifying component 1415 may determine an overlap between a downlink symbol or a flexible symbol and an uplink symbol during one or more symbols of the slot based on a second TDD configuration for a second UE, where the second TDD configuration includes a second symbol pattern for the second UE for the slot of the set of slots.

The CLI SRS transmission configuring component 1420 may transmit a configuration 1455 to the first UE for transmitting a CLI SRS in the slot based on the overlap, where the CLI SRS is configured for transmission in a downlink symbol or a flexible symbol of the second symbol pattern for the slot. In some examples, the CLI SRS transmission configuring component 1420 may transmit a second configuration to the first UE for transmitting a second SRS, the second configuration configuring the second SRS according to one or more of a first set of symbols of the slot subject to a restriction, where the first configuration configures the CLI SRS for transmission according to one or more of a second set of symbols of the slot not subject to the restriction. In some cases, the CLI SRS transmission configuring component 1420 may receive a symbol overlap indication 1450 from the symbol overlap identifying component 1415 and determine the configuration based on the symbol overlap indication 1450.

In some examples, the CLI SRS transmission configuring component 1420 may determine the timing advance for the CLI SRS for the first UE based on the timing advance for uplink shared channel transmissions for the first UE. In some cases, the configuration includes a timing advance for the CLI SRS that is different from a timing advance for uplink shared channel transmissions for the first UE. In some cases, the configuration includes an open loop power control parameter for the CLI SRS. In some cases, the configuration configures the CLI SRS to be transmitted aperiodically, semi-persistently, or periodically. In some cases, the configuration includes a cell-specific configuration, a group-specific configuration, or a UE-specific configuration for the CLI SRS. In some cases, the configuration configures the CLI SRS to be transmitted according to interlaced frequency resources, using a code of a set of orthogonal codes, according to a frequency hopping pattern, or a combination thereof. In some cases, the base station serves the first UE via a first cell and the second UE is served by a second cell of a second, different base station. In some cases, the base station serves the first UE and the second UE via a same cell.

The CLI SRS measurement configuring component 1425 may transmit a configuration 1475 to a first UE for performing a measurement of a CLI SRS in the slot based on the overlap, where the CLI SRS is configured to be transmitted by a second UE. In some examples, the CLI SRS measurement configuring component 1425 may configure the first UE to perform the measurement of the CLI SRS aperiodically, semi-persistently, or periodically. In some cases, the measurement is an RSSI measurement or an RSRP measurement. In some cases, the CLI SRS is configured to be transmitted according to interlaced frequency resources, using a code of a set of orthogonal codes, according to a frequency hopping pattern, or a combination thereof. In some cases, the base station serves the first UE via a first cell and the second UE is served by a second cell of a second, different base station. In some cases, the base station serves the first UE and the second UE via a same cell.

The measurement report receiving component 1430 may receive, from the first UE, a report 1465 including the measurement based on the CLI SRS. In some cases, the measurement report receiving component 1430 may receive the report 1465 based on a TDD configuration 1460 received from the TDD configuration identifying component 1410 or a measurement configuration 1470 received from the CLI SRS measurement configuring component.

The measurement resource component 1435 may transmit an indicator 1480 that an NZP CSI-RS resource or a CSI-IM is configured as a measurement resource for the CLI SRS. In some examples, the measurement resource component 1435 may transmit an indicator that at least a portion of a zero power CSI-RS resource is configured for rate matching a PDSCH transmission around the measurement resource for the CLI SRS. In some cases, a configuration 1485 for the measurement resource may be communicated between the CLI SRS measurement configuring component 1425 and the measurement resource component 1435. For example, the indicator 1480 may include CLI SRS measurement configuration information received from the CLI SRS measurement configuring component 1425, or the CLI SRS measurement configuration may be determined based on available measurement resources.

FIG. 15 shows a diagram of a system 1500 including a device 1505 that supports sounding reference signal transmission for UE-to-UE cross-link interference measurement in accordance with aspects of the present disclosure. The device 1505 may be an example of or include the components of device 1205, device 1305, or a base station 105 as described herein. The device 1505 may include components for bi-directional voice and data communications including components for transmitting and receiving communications, including a communications manager 1510, a network communications manager 1515, a transceiver 1520, an antenna 1525, memory 1530, a processor 1540, and an inter-station communications manager 1545. These components may be in electronic communication via one or more buses (e.g., bus 1550).

The communications manager 1510 may identify a first TDD configuration for a first UE, where the first TDD configuration includes a first symbol pattern for the first UE for a slot of a set of slots, determine an overlap between a downlink symbol or a flexible symbol and an uplink symbol during one or more symbols of the slot based on a second TDD configuration for a second UE, where the second TDD configuration includes a second symbol pattern for the slot of the set of slots, and transmit a configuration to the first UE for transmitting a CLI SRS in the slot based on the overlap, where the CLI SRS is configured for transmission in a downlink symbol or a flexible symbol of the second symbol pattern for the slot. In some cases, the base station serves the first UE via a first cell and the second UE is served by a second cell of a second, different base station. In some cases, the base station serves the first UE and the second UE via a same cell.

The communications manager 1510 may also identify a first TDD configuration for first UE, where the first TDD configuration includes a first symbol pattern for the cell for a slot of a set of slots, determine an overlap between a downlink symbol or a flexible symbol and an uplink symbol during one or more symbols of the slot based on a second TDD configuration for a second UE, where the second TDD configuration includes a second symbol pattern for the slot of the set of slots, transmit a configuration to the first UE served by the base station for performing a measurement of a CLI SRS in the slot based on the overlap, where the CLI SRS is configured to be transmitted by a second UE, and receive, from the first UE, a report including the measurement based on the CLI SRS. In some cases, the base station serves the first UE via a first cell and the second UE is served by a second cell of a second, different base station. In some cases, the base station serves the first UE and the second UE via a same cell.

The network communications manager 1515 may manage communications with the core network (e.g., via one or more wired backhaul links). For example, the network communications manager 1515 may manage the transfer of data communications for client devices, such as one or more UEs 115.

The transceiver 1520 may communicate bi-directionally, via one or more antennas, wired, or wireless links as described above. For example, the transceiver 1520 may represent a wireless transceiver and may communicate bi-directionally with another wireless transceiver. The transceiver 1520 may also include a modem to modulate the packets and provide the modulated packets to the antennas for transmission, and to demodulate packets received from the antennas.

In some cases, the wireless device may include a single antenna 1525. However, in some cases the device may have more than one antenna 1525, which may be capable of concurrently transmitting or receiving multiple wireless transmissions.

The memory 1530 may include RAM, ROM, or a combination thereof. The memory 1530 may store computer-readable code 1535 including instructions that, when executed by a processor (e.g., the processor 1540) cause the device to perform various functions described herein. In some cases, the memory 1530 may contain, among other things, a BIOS which may control basic hardware or software operation such as the interaction with peripheral components or devices.

The processor 1540 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some cases, a memory controller may be integrated into processor 1540. The processor 1540 may be configured to execute computer-readable instructions stored in a memory (e.g., the memory 1530) to cause the device 1505 to perform various functions (e.g., functions or tasks supporting sounding reference signal transmission for UE-to-UE cross-link interference measurement).

The inter-station communications manager 1545 may manage communications with other base stations 105 and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communication network technology to provide communication between base stations 105.

The code 1535 may include instructions to implement aspects of the present disclosure, including instructions to support wireless communications. The code 1535 may be stored in a non-transitory computer-readable medium such as system memory or other type of memory. In some cases, the code 1535 may not be directly executable by the processor 1540 but may cause a computer (e.g., when compiled and executed) to perform functions described herein.

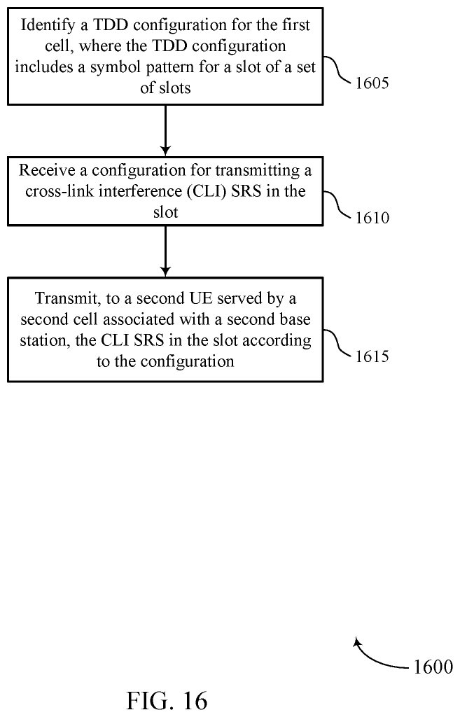

FIG. 16 shows a flowchart illustrating a method 1600 that supports sounding reference signal transmission for UE-to-UE cross-link interference measurement in accordance with aspects of the present disclosure. The operations of method 1600 may be implemented by a UE 115 or its components as described herein. For example, the operations of method 1600 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1605, the UE may identify a TDD configuration, where the TDD configuration includes a symbol pattern for a slot of a set of slots. The operations of 1605 may be performed according to the methods described herein. In some examples, aspects of the operations of 1605 may be performed by a TDD configuration identifying component as described with reference to FIGS. 8 through 11.

At 1610, the UE may receive a configuration for transmitting a CLI SRS in the slot. The operations of 1610 may be performed according to the methods described herein. In some examples, aspects of the operations of 1610 may be performed by a CLI SRS transmission configuration component as described with reference to FIGS. 8 through 11.

At 1615, the UE may transmit, to a second UE, the CLI SRS in the slot according to the configuration. The operations of 1615 may be performed according to the methods described herein. In some examples, aspects of the operations of 1615 may be performed by a CLI SRS transmitting component as described with reference to FIGS. 8 through 11. In some cases, the first UE is served by a first cell of a first base station and the second UE is served by a second cell of a second, different base station. In some cases, the first UE and second UEs are served by a same cell.

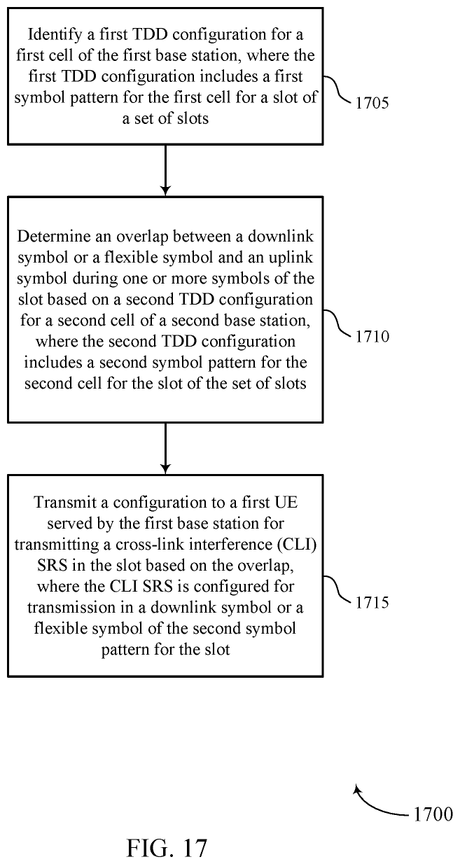

FIG. 17 shows a flowchart illustrating a method 1700 that supports sounding reference signal transmission for UE-to-UE cross-link interference measurement in accordance with aspects of the present disclosure. The operations of method 1700 may be implemented by a base station 105 or its components as described herein. For example, the operations of method 1700 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 1705, the base station may identify a first TDD configuration for a first UE, where the first TDD configuration includes a first symbol pattern for the first UE for a slot of a set of slots. The operations of 1705 may be performed according to the methods described herein. In some examples, aspects of the operations of 1705 may be performed by a TDD configuration identifying component as described with reference to FIGS. 12 through 15.

At 1710, the base station may determine an overlap between a downlink symbol or a flexible symbol and an uplink symbol during one or more symbols of the slot based on a second TDD configuration for a second UE, where the second TDD configuration includes a second symbol pattern for the slot of the set of slots. The operations of 1710 may be performed according to the methods described herein. In some examples, aspects of the operations of 1710 may be performed by a symbol overlap identifying component as described with reference to FIGS. 12 through 15.

At 1715, the base station may transmit a configuration to a first UE for transmitting a CLI SRS in the slot based on the overlap, where the CLI SRS is configured for transmission in a downlink symbol or a flexible symbol of the second symbol pattern for the slot. The operations of 1715 may be performed according to the methods described herein. In some examples, aspects of the operations of 1715 may be performed by a CLI SRS transmission configuring component as described with reference to FIGS. 12 through 15. In some cases, the base station serves the first UE via a first cell and the second UE is served by a second cell of a second, different base station. In some cases, the base station serves the first UE and the second UE via a same cell.

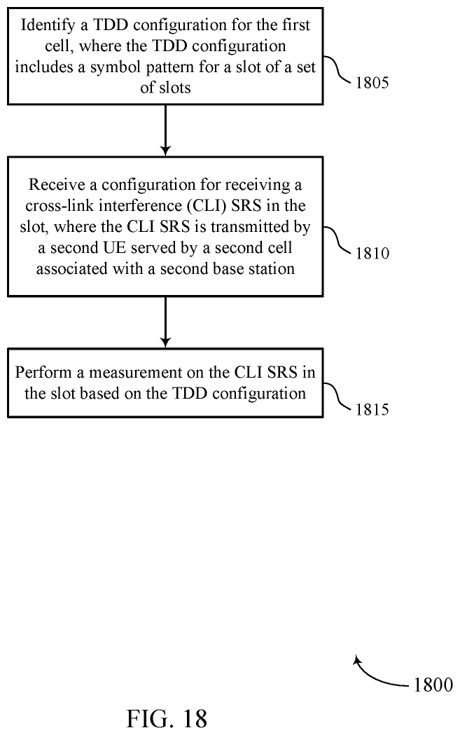

FIG. 18 shows a flowchart illustrating a method 1800 that supports sounding reference signal transmission for UE-to-UE cross-link interference measurement in accordance with aspects of the present disclosure. The operations of method 1800 may be implemented by a UE 115 or its components as described herein. For example, the operations of method 1800 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 1805, the UE may identify a TDD configuration, where the TDD configuration includes a symbol pattern for a slot of a set of slots. The operations of 1805 may be performed according to the methods described herein. In some examples, aspects of the operations of 1805 may be performed by a TDD configuration identifying component as described with reference to FIGS. 8 through 11.

At 1810, the UE may receive a configuration for receiving a CLI SRS in the slot, where the CLI SRS is transmitted by a second UE. The operations of 1810 may be performed according to the methods described herein. In some examples, aspects of the operations of 1810 may be performed by a CLI SRS reception configuration component as described with reference to FIGS. 8 through 11.

At 1815, the UE may perform a measurement on the CLI SRS in the slot based on the TDD configuration. The operations of 1815 may be performed according to the methods described herein. In some examples, aspects of the operations of 1815 may be performed by a CLI SRS measuring component as described with reference to FIGS. 8 through 11. In some cases, the first UE is served by a first cell of a first base station and the second UE is served by a second cell of a second, different base station. In some cases, the first UE and second UEs are served by a same cell.

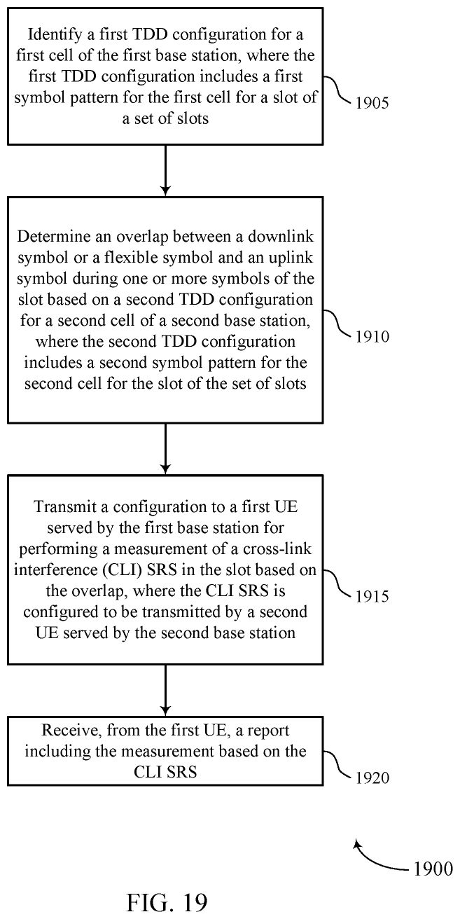

FIG. 19 shows a flowchart illustrating a method 1900 that supports sounding reference signal transmission for UE-to-UE cross-link interference measurement in accordance with aspects of the present disclosure. The operations of method 1900 may be implemented by a base station 105 or its components as described herein. For example, the operations of method 1900 may be performed by a communications manager as described with reference to FIGS. 12 through 15. In some examples, a base station may execute a set of instructions to control the functional elements of the base station to perform the functions described below. Additionally or alternatively, a base station may perform aspects of the functions described below using special-purpose hardware.

At 1905, the base station may identify a first TDD configuration for a first UE, where the first TDD configuration includes a first symbol pattern for the first UE for a slot of a set of slots. The operations of 1905 may be performed according to the methods described herein. In some examples, aspects of the operations of 1905 may be performed by a TDD configuration identifying component as described with reference to FIGS. 12 through 15.

At 1910, the base station may determine an overlap between a downlink symbol or a flexible symbol and an uplink symbol during one or more symbols of the slot based on a second TDD configuration for a second UE, where the second TDD configuration includes a second symbol pattern for the slot of the set of slots. The operations of 1910 may be performed according to the methods described herein. In some examples, aspects of the operations of 1910 may be performed by a symbol overlap identifying component as described with reference to FIGS. 12 through 15.

At 1915, the base station may transmit a configuration to the first UE for performing a measurement of a CLI SRS in the slot based on the overlap, where the CLI SRS is configured to be transmitted by a second UE. The operations of 1915 may be performed according to the methods described herein. In some examples, aspects of the operations of 1915 may be performed by a CLI SRS measurement configuring component as described with reference to FIGS. 12 through 15.

At 1920, the base station may receive, from the first UE, a report including the measurement based on the CLI SRS. The operations of 1920 may be performed according to the methods described herein. In some examples, aspects of the operations of 1920 may be performed by a measurement report receiving component as described with reference to FIGS. 12 through 15. In some cases, the base station serves the first UE via a first cell and the second UE is served by a second cell of a second, different base station. In some cases, the base station serves the first UE and the second UE via a same cell.

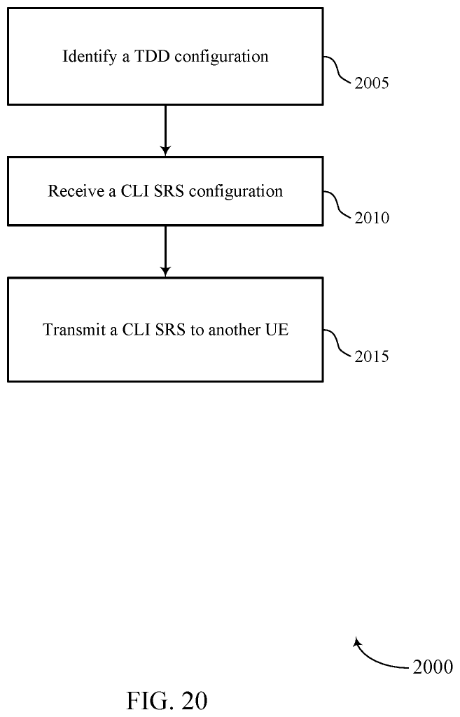

FIG. 20 shows a flowchart illustrating a method 2000 that supports sounding reference signal transmission for UE-to-UE cross-link interference measurement in accordance with aspects of the present disclosure. The operations of method 2000 may be implemented by a UE 115 or its components as described herein. For example, the operations of method 2000 may be performed by a communications manager as described with reference to FIGS. 8 through 11. In some examples, a UE may execute a set of instructions to control the functional elements of the UE to perform the functions described below. Additionally or alternatively, a UE may perform aspects of the functions described below using special-purpose hardware.

At 2005, the UE may identify a TDD configuration. The TDD configuration may include a symbol pattern for a slot of a set of slots. For example, the TDD configuration may indicate which symbols of the slot are configured for uplink signaling, downlink signaling, or both. The operations of 2005 may be performed according to the methods described herein. In some examples, aspects of the operations of 2005 may be performed by a TDD configuration identifying component as described with reference to FIGS. 8 through 11.

At 2010, the UE 115 may receive a CLI SRS configuration. The CLI SRS configuration may be for the UE 115 to transmit a CLI SRS in the slot. In some cases, the CLI SRS configuration may indicate which symbols of the slot the UE 115 is to transmit the CLI SRS. The operations of 2010 may be performed according to the methods described herein. In some examples, aspects of the operations of 2010 may be performed by a CLI SRS transmission configuration component as described with reference to FIGS. 8 through 11.

At 2015, the UE may transmit the CLI SRS to another UE 115. For example, the UE 115 (e.g., a first UE 115) may transmit the CLI SRS in the slot to a second UE 115 according to the configuration. The operations of 2015 may be performed according to the methods described herein. The second UE 115 may monitor for the CLI SRS based on a configuration received from its serving cell. In some examples, aspects of the operations of 2015 may be performed by a CLI SRS transmitting component as described with reference to FIGS. 8 through 11. In some cases, the first UE may be served by a first cell of a first base station and the second UE may be served by a second cell of a second, different base station. In some cases, the first UE and second UEs may be served by a same cell.

It should be noted that the methods described herein describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

A macro cell generally covers a relatively large geographic area (e.g., several kilometers in radius) and may allow unrestricted access by UEs with service subscriptions with the network provider. A small cell may be associated with a lower-powered base station, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a first user equipment (UE) served by a cell associated with a base station, comprising:
identifying a time division duplexing (TDD) configuration for the cell, wherein the TDD configuration comprises a symbol pattern for a slot of a plurality of slots;
receiving a configuration for receiving a cross-link interference (CLI) sounding reference signal (SRS) in the slot, wherein the CLI SRS is transmitted by a second UE; and
performing a measurement on the CLI SRS in the slot based at least in part on the TDD configuration.

2. The method of claim 1, wherein the TDD configuration is a first TDD configuration, the method further comprising:
identifying a second TDD configuration for the cell comprising a second symbol pattern for the slot based at least in part on the configuration for receiving the CLI SRS in the slot; and
performing the measurement on the CLI SRS in the slot based at least in part on the second symbol pattern for the slot.

3. The method of claim 2, wherein a first symbol of the slot is configured as an uplink symbol in the symbol pattern for the slot, the first symbol of the slot is configured as a flexible symbol or a downlink symbol in the second symbol pattern for the slot, and the CLI SRS is received during the first symbol.

4. The method of claim 1, further comprising:
receiving an indicator that a non-zero power (NZP) channel state information reference signal (CSI-RS) resource or a CSI interference measurement (CSI-IM) is configured as a measurement resource for the CLI SRS.

5. The method of claim 4, further comprising:
receiving an indicator that at least a portion of a zero power CSI-RS resource is configured for rate matching a physical downlink shared channel (PDSCH) transmission around the measurement resource for the CLI SRS.

6. The method of claim 1, wherein the measurement is a reference signal strength indicator (RSSI) measurement or a reference signal received power (RSRP) measurement.

7. The method of claim 1, further comprising:
reporting the measurement for the CLI SRS to the base station.

8. The method of claim 1, wherein the measurement for the CLI SRS is configured to be performed aperiodically, semi-persistently, or periodically.

9. The method of claim 1, wherein the CLI SRS is configured to be transmitted according to interlaced frequency resources, using a code of a plurality of orthogonal codes, according to a frequency hopping pattern, or a combination thereof.

10. The method of claim 1, wherein the CLI SRS is configured to be transmitted on a plurality of beams corresponding to a plurality of transmit ports.

11. The method of claim 1, wherein the first UE is served by a first cell of a first base station and the second UE is served by a second cell of a second, different base station.

12. The method of claim 1, wherein the first UE and second UEs are served by a same cell.

13. A method for wireless communication at a first user equipment (UE) served by a cell associated with a base station, comprising:
identifying a time division duplexing (TDD) configuration for the cell, wherein the TDD configuration comprises a symbol pattern for a slot of a plurality of slots;
receiving a configuration for transmitting a cross-link interference (CLI) sounding reference signal (SRS) in the slot; and
transmitting, to a second UE, the CLI SRS in the slot according to the configuration.

14. The method of claim 13, wherein the CLI SRS is a first SRS and the configuration is a first configuration, the method further comprising:
receiving a second configuration for transmitting a second SRS, the second configuration configuring the second SRS according to one or more of a first set of symbols of the plurality of slots subject to a restriction, wherein the first configuration configures the CLI SRS for transmission according to one or more of a second set of symbols of the slot not subject to the restriction.

15. The method of claim 13, wherein the transmitting the CLI SRS applies a timing advance for uplink shared channel transmissions.

16. The method of claim 13, wherein the transmitting the CLI SRS applies a timing advance for the CLI SRS that is different from a timing advance for uplink shared channel transmissions.

17. The method of claim 16, further comprising:
determining that an uplink transmission during an uplink symbol period subsequent to the CLI SRS transmission is scheduled to collide with the CLI SRS transmission based at least in part on the timing advance for the CLI SRS and the timing advance for uplink shared channel transmissions; and
dropping the uplink transmission from the uplink symbol period.

18. The method of claim 16, wherein the timing advance for the CLI SRS is a zero-valued timing advance.

19. The method of claim 16, further comprising:
receiving the timing advance for the CLI SRS from the base station.

20. The method of claim 13, wherein a transmit power for the CLI SRS is based at least in part on a transmit power control (TPC) loop for physical uplink shared channel transmissions.

21. The method of claim 13, wherein a transmit power for the CLI SRS is based at least in part on an open loop power control parameter for the CLI SRS.

22. The method of claim 21, wherein the open loop power control parameter comprises a fixed power level for CLI SRS transmissions.

23. The method of claim 13, wherein the CLI SRS is configured to be transmitted aperiodically, semi-persistently, or periodically.

24. The method of claim 13, wherein the CLI SRS is configured to be transmitted according to interlaced frequency resources, using a code of a plurality of orthogonal codes, according to a frequency hopping pattern, or a combination thereof.

25. The method of claim 13, wherein the CLI SRS is transmitted on a plurality of beams corresponding to a plurality of transmit ports.

26. The method of claim 13, further comprising:
applying a precoding matrix to the CLI SRS transmission corresponding to a serving precoding matrix.

27. The method of claim 13, wherein the first UE is served by a first cell of a first base station and the second UE is served by a second cell of a second, different base station.

28. The method of claim 13, wherein the first UE and second UEs are served by a same cell.

29. An apparatus for wireless communication at a first user equipment (UE) served by a cell associated with a base station, comprising:
a processor,
memory in electronic communication with the processor; and
instructions stored in the memory and executable by the processor to cause the apparatus to:
identify a time division duplexing (TDD) configuration for the cell, wherein the TDD configuration comprises a symbol pattern for a slot of a plurality of slots;
receive a configuration for receiving a cross-link interference (CLI) sounding reference signal (SRS) in the slot, wherein the CLI SRS is transmitted by a second UE; and
perform a measurement on the CLI SRS in the slot based at least in part on the TDD configuration.

30. The apparatus of claim 29, wherein the TDD configuration is a first TDD configuration, and wherein the instructions are further executable by the processor to cause the apparatus to:
identify a second TDD configuration for the cell comprising a second symbol pattern for the slot based at least in part on the configuration for receiving the CLI SRS in the slot; and
perform the measurement on the CLI SRS in the slot based at least in part on the second symbol pattern for the slot.

31. An apparatus for wireless communication at a first user equipment (UE) served by a cell associated with a base station, comprising:
a processor,
memory in electronic communication with the processor; and
instructions stored in the memory and executable by the processor to cause the apparatus to:
identify a time division duplexing (TDD) configuration for the cell, wherein the TDD configuration comprises a symbol pattern for a slot of a plurality of slots;
receive a configuration for transmitting a cross-link interference (CLI) sounding reference signal (SRS) in the slot; and
transmit, to a second UE, the CLI SRS in the slot according to the configuration.
